(19) United States
(12) Patent Application Publication
(10) Pub. No.: US 2008/0211408 A1
(43) Pub. Date: Sep. 4, 2008

(54) Plasma Display Panel and Method for Manufacturing Same

(76) Inventors: Hiroyuki Yamakita, Osaka (JP); Masatoshi Kitagawa, Osaka (JP); Mikihiko Nishitani, Nara (JP); Noriyasu Echigo, Hyogo (JP); Tomohiro Okumura, Osaka (JP); Hiroaki Ishio, Osaka (JP); Hikaru Nishitani, Nara (JP)

Correspondence Address: SNELL & WILMER L.L.P. (Matsushita), 600 ANTON BOULEVARD, SUITE 1400, COSTA MESA, CA, 92626, US

(21) Appl. No.: 11/572,902

(22) PCT Filed: Aug. 11, 2005
(86) PCT No.: PCT/JP2005/014741

§ 371 Date: Nov. 29, 2007

(30) Foreign Application Priority Data
Aug. 17, 2004 (JP) 2004-237717
Sep. 1, 2004 (JP) 2004-254891
Mar. 18, 2005 (JP) 2005-080490

(51) Int. Cl. H01J 17/49; H01J 9/02

(52) U.S. Cl. 313/586; 445/25

(57) ABSTRACT

An object of the present invention is to provide a plasma display panel and a manufacturing method thereof that can prevent a dielectric layer and a protective layer from being deteriorated and give excellent image display performance, by performing a sealing process effectively. The object can be realized by a plasma display panel including a front panel 10 and a back panel 11 arranged in opposing to each other at a certain gap, the front panel and the back panel being sealed by a sealing layer 17 that is provided on entire peripheral portions of main surfaces of the front panel and the back panel, and the sealing layer is composed of at least one material selected from the group consisting of an organic resin material, an inorganic material, and a metal material (more specifically, a silica material as a main component and an epoxy resin material).

### TECHNICAL FIELD

The present invention relates to a plasma display panel and a manufacturing method thereof, and especially relates to an improvement of reliability for a sealing technology in manufacturing processes thereof.

### BACKGROUND ART

A plasma display panel (hereinafter, merely referred to as “PDP”) is known as one of typical flat-panel displays (FPD), and it is designed to commercialize an image display device using a PDP. A PDP is classified into a direct current type (DC type) and an alternating current type (AC type). At a present moment, an AC type PDP has a higher technical potential as a construction of a large-screen display than a DC type PDP. Especially, a surface discharge type PDP, that has an excellently long life property in the AC type PDP, is becoming a main product.

FIG. 21 is a panel cross section showing a construction around a discharge cell of a general AC surface discharge type PDP. FIG. 21B is a cross section along a line xy shown in FIG. 21A.

A PDP1c has a construction in which a front panel FP and a back panel BP are arranged in opposing to each other at a certain gap, the front panel FP and the back panel BP are sealed by a sealing layer (not illustrated) provided on entire peripheral portions of main surfaces of the front panel and the back panel, and a discharge gas is enclosed in an internal space between the front panel and the back panel.

On a surface of a front panel glass 10c of the front panel FP, a plurality of a pair of display electrodes 4c are arranged into stripes. The pair of display electrodes is composed of wide belt-like transparent electrodes 85c and 86c that are ITO films (indium tin oxide), and a pair of bus electrodes 89c that is made by calcining an Ag paste and the like so as to be electrically connected to the transparent electrodes 85c and 86c. A display electrode 5c is a scan electrode and a display electrode 6c is a sustain electrode, and the display electrode 5c and the display electrode 6c are arranged in opposing to each other at a certain discharge gap on the surface of the front panel glass 10c.

Moreover, on the front panel glass 10c, a FP side dielectric layer 87c that is composed of another glass material, and a protective layer 88c that is composed of magnesium oxide (MgO) are laminated in sequence for covering the pair of display electrodes 4c.

On the other hand, on a surface of a back panel glass 11c of the back panel BP, a plurality of data electrodes 812c are arranged into stripes, and a BP side dielectric layer 813c is formed for covering the plurality of data electrodes 812c. On the BP side dielectric layer 813c, a plurality of barrier ribs 14c are formed between the plurality of data electrodes 812c, and a phosphor layer 15c of any of colors red, green, or blue is formed between the plurality of barrier ribs 14c. A tip tube 817c as a flow passage shown in FIG. 21 is arranged to be connected to a discharge space in order to reduce a pressure inside of the discharge space and enclose a gas therein.

A discharge cell is arranged according to an area in which the pair of electrodes 4c intersect with the data electrode 812c with the discharge space in between, and a plurality of the discharge cells are arranged in a matrix on the whole panel. In a representative PDP, one pixel (picture element) is composed of three discharge cells of three colors red, green, or blue that are located next to each other along a longitudinal direction of the pair of electrodes 4c.

A patent document 1 discloses that the front panel FP and the back panel BP having the above-mentioned construction are arranged in opposing to each other so that the protective layer 88c contacts with the barrier ribs 14c, both of the panels 82c and 83c are glued together by applying a sealing layer material on entire peripheral portions of main surfaces of both of the panels 82c and 83c. Then, a sealing layer is formed in a sealing process to seal both of the panels 82c and 83c so that an internal space between both of the panels 82c and 83c is a discharge space. After this, the discharge space is depressurized via the tip tube 817c, and a mixing gas composed of a rare gas-such as a Xe—Ne gas or a Xe—He gas and the like as a discharge gas is enclosed in the discharge space at a predetermined pressure. Then, the tip tube 817c is removed.

The PDP1c is completed through the above-mentioned process.

Here, in a general manufacturing process of a PDP, when a front panel FP or a back panel BP is exposed to the atmosphere, a dielectric layer and a protective layer (especially magnesium oxide) are chemically converted to hydroxide or a carbon compound, because of being contacted with an impure gas in the atmosphere such as air, moisture, a carbon dioxide. This causes a problem that it is difficult to obtain the good image display performance because a discharge characteristic changes.

Except for a case in which a front panel FP or a back panel BP is exposed to the atmosphere, there is the possibility that an organic component (carbon component) included in a glass frit for sealing remains in a sealing process, and an impure gas caused by the component has a harmful effect on a dielectric layer and a protective layer. This problem is caused especially when a sealing process is performed at a relatively high temperature such as equal to or higher than 450° C. because a binder component in a sealing layer is gasified.

Therefore, some measurements are conventionally taken to prevent impurities from attaching to a dielectric layer and a protective layer.

For example, patent documents 2 and 4 disclose the following technology. A sealing process is performed on a PDP in a sealed chamber that is intercepted from the atmosphere under a reduced-pressure atmosphere. This prevents impurities from being mixed into a PDP.

The patent document 2 also discloses the following technology. The tentative calcination of a glass frit is performed under a reduced-pressure atmosphere. After an organic component is removed to some extent, both of panels FP and BP are glued together, and the actual calcination is performed. This prevents an organic component caused by a glass frit from attaching a protective layer and the like.

### Patent Document 1: Japanese Published Patent Application No. 2001-351532

Patent Document 2: Japanese Published Patent Application No. H10-40818

### Patent Document 3: Japanese Published Patent Application No. 2001-28240

Patent Document 4: Japanese Published Patent Application No. H09-251839

### DISCLOSURE OF THE INVENTION

### Problems the Invention is going to Solve

However, in the conventional technology mentioned above, unnecessary chemical changes of a dielectric layer and a protective layer are not prevented effectively in a present circumstance.

In other words, if a sealing process is performed under a reduced-pressure atmosphere or a vacuum atmosphere by keeping both of panels FP and BP away from the atmosphere using a chamber or the like, an impure gas caused by the atmosphere is prevented from being mixed into both of the panels. However, an impure gas caused by a sealing layer material that occurs in a discharge space in the sealing process cannot be removed.

The patent document 1 discloses a technology to remove an impure gas remaining in an internal space between both panels FP and BP through a tip tube (a piping member) as a flow passage in a sealing process. However, exhaust resistance is high because a discharge space is in a range of 100 μm to 200 μm inclusive in practice. As a result, removal efficiency is not good. Even if a better material is provided in an internal space between both panels FP and BP for removing an impure gas by adsorbing, the impure gas cannot be removed completely.

Since a tip tube is normally a small tube, it takes a relatively long time to remove a gas from the internal space. Therefore, a gas cannot be exhausted rapidly, and it is difficult to effectively prevent impurities from being adsorbed to a protective layer and the like.

To solve the above-mentioned problem, the present invention aims to provide a PDP that can prevent a dielectric layer and a protective layer from being deteriorated and give the good image display performance by performing an effective sealing process, and a manufacturing method of the PDP.

### Means of Solving the Problems

The above object is fulfilled by a plasma display panel including a front panel and a back panel arranged in opposing to each other at a certain gap, the front panel and the back panel being sealed by a sealing layer that is provided on entire peripheral portions of main surfaces of the front panel and the back panel, and the sealing layer is composed of at least one material selected from the group consisting of an organic resin material, an inorganic material, and a metal material. For example, a sealing layer can be composed of a silica material as a main component and an epoxy resin material. More specifically, the sealing layer can be composed of about 70 wt % of a silica component and an epoxy resin material. Note that it is preferable not to add a xylene component.

In a PDP having the above-mentioned construction, a sealing process can be performed at a lower temperature than ever before by selecting a material of a sealing layer.

This prevents a gas caused by a sealing layer material from occurring in a sealing process, and unnecessary chemical changes of a dielectric layer and a protective layer caused by the gas can be prevented. Therefore, the stable image display performance can be realized over a long period of time.

Here, the sealing layer is formed under a reduced-pressure atmosphere in a discharge gas.

Also, a discharge gas is enclosed in an internal space between the front panel and the back panel through a flow passage.

Moreover, the sealing layer is a double enclosing layer composed of an inner layer and an outer layer on the main surfaces of the front panel and the back panel, and the outer layer is provided so as to surround the inner layer.

One of the inner layer and the outer layer is a high-airtight enclosing layer, and the other is a high-strength enclosing layer.

Also, the inner layer is the high-strength enclosing layer, and the outer layer is the high-airtight enclosing layer.

Note that a width of each of the inner layer and the outer layer is different from each other along the main surfaces of the front panel and the back panel.

Furthermore, when the double enclosing layer is composed of a high-strength enclosing layer and a high-airtight enclosing layer that is surrounded by the high-strength enclosing layer, the high-strength enclosing layer is wider than the high-airtight enclosing layer.

Here, a dielectric layer and a protective layer are formed in sequence on the main surface of at least one of the front panel and the back panel under a reduced-pressure atmosphere.

The above object is also fulfilled by using a manufacturing method of a plasma display panel having a sealing process of arranging a front panel and a back panel in opposing to each other at a certain gap, and sealing the front panel and the back panel by a sealing layer that is provided on entire peripheral portions of main surfaces of the front panel and the back panel, and in the sealing process, a silica material as a main component and an epoxy resin material are used as the material of the sealing layer.

Also, in the sealing process, the front panel and the back panel are sealed in a discharge gas.

Moreover, in the sealing process, the sealing layer is formed using at least one method out of a heating adhesion method, an ultraviolet cure method, a laser ablation method, and an ultrasonic welding method.

When the heating adhesion method is used in the sealing process, an aging process is performed after the sealing process, and in the aging process, the heating adhesion method is continuously performed supplementary.

Furthermore, before the sealing process, a panel forming process is performed to compose at least one of the front panel and the back panel using a forming method in which a plurality of electrodes and a dielectric layer are formed on a main surface of a panel substrate in sequence, and the panel forming process and the sealing process are continuously performed under a reduced-pressure atmosphere.

In the present invention mentioned above, it is possible to exhaust a gas from inside of a PDP and enclose a discharge gas rapidly therein without using a tip tube as the conventional technology because processes from the forming of a front panel and a back panel to the end of a sealing process are performed without being exposed to the air. In addition, an impure gas can be prevented from being mixed into the PDP. Therefore, in the PDP, unnecessary chemical changes of a protective layer and a dielectric layer caused by moisture, an impure gas, and the like can be prevented over a long period of time.

Moreover, because a tip tube is not used in the present invention, a hole for exhausting a gas from inside of a PDP and for enclosing a discharge gas therein is not required to be formed. Therefore, a flat PDP having a good appearance can be realized.

Also, before the sealing process, a panel forming process is performed to compose at least one of the front panel and the back panel using a forming method in which a plurality of electrodes and a dielectric layer are formed on a main surface of a panel substrate in sequence, and in the panel forming process, the dielectric layer is formed using a CVD method.

Here, the CVD method is a plasma CVD method.

Also, before the sealing process, a panel forming process is performed to compose the front panel using a forming method in which a plurality of electrodes and a dielectric layer are formed on a main surface of a panel substrate in sequence and a protective layer is formed on the dielectric layer, and in the panel forming process, the protective layer is formed using a vacuum process method.

Moreover, before the sealing process, an electrode forming process is performed to form a plurality of electrodes on at least one of main surfaces of panel substrates of the front panel and the back panel, and in the electrode forming process, the plurality of electrodes are formed by an Al—Nd material using a vacuum process method.

Furthermore, before the sealing process, a panel forming process is performed to compose the front panel using a forming method in which a plurality of electrodes, a dielectric layer, and a protective layer are formed on a main surface of a panel substrate in sequence, and the panel forming process is performed at a low temperature in a range of an ambient temperature to 300° C. inclusive.

This prevents both of panels from being warped or cracked caused in a conventional panel forming process at a high temperature and an assembling sealing process. Also, most processes can be performed under a reduced-pressure atmosphere or a vacuum atmosphere. As a result, a quality of a PDP can be stable.

### BEST MODE FOR CARRYING OUT THE INVENTION

The following describes each of preferable embodiments of the present invention. Note that the description of each of the embodiments can be combined each other unless deviating from a purpose of the present invention.

### First Embodiment

### 1.1 Construction of PDP

FIG. 1 shows a construction of a PDP of a first embodiment. FIG. 1A is a cross section in a direction of a panel thickness, and FIG. 1B is a front view of a panel.

Since the whole construction of a PDP is as described in FIG. 21, a construction with a focus on a difference from a conventional construction will be described here.

Here, a PDP has a specification applying to a NTSC specification of 42-inch class as an example. However, the present invention may apply to other specifications and sizes such as XGA, SXGA, or the like.

The construction of the PDP1 shown in FIG. 1 is classified broadly into a front panel FP and a back panel BP that are arranged so that each of main surfaces are opposite to each other.

On a main surface of a front panel glass 10 as a substrate of the front panel FP, a plurality of a pair of display electrodes 4 (a scan electrode 5 and a sustain electrode 6) are formed. Each of the pair of display electrodes 4 are composed of belt-like transparent electrodes 155 and 156 (0.1 μm in thickness, and 150 μm in width) that are made by a transparent conductive material such as ITO, SnO₂ or the like, and a pair of bus electrodes 9 (7 μm in thickness, and 95 μm in width) that are made by an Al—Nd material having superior electrical conductivity. And the transparent electrodes 155 and 156 are laminated on each of the pair of bus electrodes 9. In the first embodiment, each of the pair of bus electrodes 9 is composed of the Al—Nd material to decrease sheet resistance of the transparent electrodes 155 and 156, and supply electricity effectively.

Note that an Al metal alloy thin film including at least a rare earth metal may be used as a bus electrode in the present invention.

On the whole main surface of the front panel glass 10 on which a plurality of the pair of display electrodes 4 are arranged, a dielectric layer (a FP side dielectric layer) 7, having a thickness of 20 μm to 50 μm, that is made of a glass material mainly containing SiO₂ is formed using a screen printing method.

A protective layer 8 having a thickness of about 1.0 μm is formed on a surface of the FP side dielectric layer 7.

The main surfaces of the front panel FP and the back panel BP, that have the above-mentioned construction, are sealed by a double sealing layer 17 (composed of a first enclosing layer 171 and a second enclosing layer 172) that is arranged on entire peripheral portions of the main surfaces of the front panel FP and the back panel BP. The first enclosing layer 171 has a high airtight characteristic, and the second enclosing layer 172 has a high strength characteristic (in other words, a high adherent characteristic). Therefore, the whole sealing layer 17 has an excellent sealing characteristic. Materials of the first enclosing layer 171 and the second enclosing layer 172 do not include a binder component that is used as a general sealing layer material. This prevents an impure gas caused by the binder component from occurring in a sealing process. Therefore, an impure gas is unlikely to attach to a protective layer and the like in the PDP in a sealing process.

Here, the sealing layer 17 is composed of at least one material selected from the group consisting of an organic resin material, an inorganic material, and a metal material. For example, a sealing layer is composed of a composite material containing a silica material as a main component and an organic material such as an epoxy resin material and the like. Note that a result of an experiment by inventors of the present invention proves that it is preferable not to add a xylene component.

As a sealing layer to obtain a high airtight characteristic, the sealing layer is composed of about 70 wt % of a silica component and an epoxy resin material.

To obtain a high strength characteristic, an acrylic UV-curable resin material can be used as an organic material.

Although the present invention has a construction in which the first enclosing layer 171 having a high airtight characteristic is more internally located than the second sealing layer 172 having a high strength characteristic so as to be exposed to a discharge space 30 in the first embodiment, the present invention is not limited to the construction.

A construction of the sealing layer 17 is not limited to the double sealing layer composed of the enclosing layers 171 and 172, and may be a multiple construction that is more than a double construction (such as a construction in which a high-airtight enclosing layer and a high-strength enclosing layer are arranged alternately). By contraries, the sealing layer 17 may have a construction in which a single sealing layer 17 is arranged. In the case of the construction of the single sealing layer, it is preferable to form the single sealing layer 17 so as to have both of a high airtight characteristic and a high strength characteristic.

A Xe—Ne rare gas is enclosed in the discharge space 30 as a discharge gas at a pressure of 60 kPa to 70 kPa. It is known that if a partial pressure of Xe of a discharge gas is increased, the discharge efficiency is improved.

The discharge space 30 is each space divided by a BP side dielectric layer 13, a phosphor layer 15, and two barrier ribs 14 adjacent to each other between the front panel FP and the back panel BP. An area in which the pair of electrodes 4 (the scan electrode 5 and the sustain electrode 6) intersect with one data electrode 12 with the discharge space 30 in between corresponds to a discharge cell relating to an image display.

The PDP1 having the above-mentioned construction is composed as a PDP device by being connected to a known drive circuit.

When the PDP1 is driven, in a specified cell, an address discharge starts between the data electrode 12 and one of the pair of electrodes 4, an ultraviolet ray such as a short-wavelength ultraviolet ray and the like (a Xe resonance line having an wavelength of about 147 nm, and a Xe molecular line having an wavelength of about 173 nm) occurs by a sustained discharge between the pair of electrodes 4, and the phosphor layer 15, that receives the ultraviolet ray, emits an optical wavelength to display an image. As a representative image display method, a field gradation display method is employed. By selecting a plurality of periods (subfield) having the different number of discharge according to a gradation, one image is displayed by gradation.

In the front panel FP of the PDP1, the FP side dielectric layer 7 and the protective layer 8 are formed continuously under a reduced-pressure atmosphere without being exposed to the atmosphere. Also, in a sealing process, the sealing layer 17 arranged on the entire peripheral portions of the main surfaces of the front panel FP and the back panel BP is composed of at least one material selected from the group consisting of an organic resin material (an epoxy resin or an acrylic UV-curable resin), an inorganic material (a silica material), and a metal material. And, the sealing layer 17 as a double sealing layer is composed of the first enclosing layer 171 and the second enclosing layer 172.

Since the sealing layer material is selected, in the PDP of the first embodiment, a sealing process can be performed at a lower temperature than ever before, and the process can be performed continuously under a reduced-pressure atmosphere As a result, as described later, it is possible to exhaust a gas from the inside of the PDP1 and enclose a discharge gas rapidly therein without using a tip tube. This prevents an impure gas from being mixed into the PDP1 effectively. Therefore, a chemical change of a protective layer and a dielectric layer caused by moisture, an impure gas, and the like can be prevented for an extended period, and the excellent image display performance can be obtained.

By manufacturing the PDP of the first embodiment actually, it was proved that the PDP has a longer operating life than a conventional PDP and can maintain the reliability such as the excellent image display performance and the like for an extended period.

More specifically, it is confirmed that sustained discharge voltage is reduced and luminous efficiency is improved up to about 1.5 times compared with a conventional PDP whose front panel FP and back panel BP are manufactured by being exposed to the atmosphere.

The PDP has an about three times longer operating life than a conventional PDP while maintaining high luminous efficiency, and an improvement and reliability of the luminous efficiency are confirmed.

The reason is the following. In the PDP1, the dielectric layers 7 and 13, and the protective layer 8 are formed without being exposed to the atmosphere. Also, a sealing process is also performed without being exposed to the atmosphere. This prevents impurities in the atmosphere from being mixed into the PDP. Moreover, the material of the sealing layer does not include a binder component, and the sealing process is performed at a low temperature. Therefore, an unnecessary impure gas is unlikely to occur. As a result, as the whole PDP1, a chemical change of a dielectric layer and a protective layer caused by an impure gas and moisture can be prevented, and the performance right after the manufacturing can be maintained for an extended period.

### 1.2 Manufacturing Method of PDP

Here, main manufacturing processes of the PDP1 will be described in sequence. FIG. 4 is a flowchart showing a manufacturing process of the PDP1. Note that the manufacturing process is basically common to a PDP of each of embodiments from second embodiment to thirteenth embodiment described later.

### [Manufacturing of Front Panel FP]

The plurality of the pair of display electrodes 4, the FP side dielectric layer 7, and the protective layer 8 are formed in sequence on the main surface of the front panel glass 10 (S1 to S4). As shown in FIG. 4, in the present invention, these processes are performed continuously under a reduced-pressure atmosphere to prevent the front panel glass from being exposed to the atmosphere during the manufacturing. The reduced-pressure state is maintained not only when the front panel FP is practically formed but also when being moved to a next process, being stored, and being moved to a sealing and enclosing process.

Here, “reduced-pressure state” is a vacuum state, a vacuum reduced-pressure state, or a reduced-pressure state replaced with an inert gas.

More specifically, each of the processes is performed as described below.

### <Formation of Display Electrode 4>

Firstly, any of transparent electrode materials such as ITO, SnO₂, ZnO, and the like is formed at least on a portion of the main surface of the front panel glass 10 at about 100 nm in thickness using a sputtering method. At this time, by using a photolithographic method, a patterning is performed using a desired pattern (such as a wide belt-like pattern) to obtain the transparent electrodes 155 and 156 opposing to each other parallel and widely with a discharge gap in between as shown in FIG. 5 (PROCESS A) (S1).

After the transparent electrodes 155 and 156 are formed, an Al metal alloy thin film including at least a rare earth metal, having an excellent electric characteristic, such as Al—Nd and the like is laminated on the transparent electrodes 155 and 156 uniformly at about 1 μm in thickness using a vacuum film forming process method such as a vacuum evaporation method, an electron beam evaporation method, a plasma beam evaporation method, a sputtering method and the like. Then, a patterning is performed on the thin film using a dry etching method and a photo etching method to form the pair of the bus electrodes 9 having the desired pattern shown in FIG. 5 (PROCESS B) (S2). The film forming is performed in a vacuum or under a reduced-pressure in which a sputtering gas is filled and a panel temperature is set in a range of an ambient temperature to 300° C. inclusive.

Here, “vacuum film forming process method” is a method of a process of forming a thin film in a vacuum state or a reduced-pressure state. If an electrode is made using a thin film formed by the vacuum film forming process method, a dielectric layer laminated on the thin film can be prevented from being transformed into a convex state, a dielectric layer without a variation in the film pressure distribution can be formed, and a partial dielectric breakdown caused by an electrode shape (such as a dielectric breakdown occurring in an area corresponding to an edge portion of an electrode) can be prevented from occurring.

Since the Al—Nd material is chemically stable for a glass material, a migration phenomenon, in which a metal component of an electrode is diffused in the FP side dielectric layer 7, does not occur as time passes after a PDP is manufactured. Therefore, an electrode construction with high reliability can be obtained.

Note that the bus electrode 9 can be made using a thick film forming method as a construction of an Ag electrode, Cr/Cu/Cr laminated electrode, and the like.

By the above-mentioned method, the display electrode 4 having an excellent electric characteristic is formed with more even film thickness and shape compared with the thick film forming method and the like.

A harmful influence caused by impurities in the atmosphere as a problem of the present invention is mainly caused by the adsorption of the impurities to a protective layer (magnesium oxide). Considering the above-mentioned fact, in a forming process of the display electrode, or between the forming process and the following forming process of the FP side dielectric layer 7, if the panel is exposed to the atmosphere, a tentative effect of the present invention can be obtained. However, it is preferable to continuously perform the processes S1 to S4 without being exposed to the atmosphere in order to obtain a higher effect of the present invention.

### <Formation of FP Side Dielectric Layer 7>

Next, the FP side dielectric layer 7 having a thickness of 110 μm of right after the manufacturing is formed on the surface of the front panel glass 10 so as to cover the arranged display electrode 4 (S3).

Regarding the FP side dielectric layer 7, a dielectric constant is in a range of 2 to 5 inclusive, and it is preferable to use a material that can form a dense dielectric layer having the dielectric strength voltage that is equal to or higher than 1.0×10⁶ V/cm. Therefore, a material such as SiO₂ and the like can be used.

More specifically, a dielectric layer material including TEOS (tetraethoxysilane) is used for the FP side dielectric layer 7, and a film can be formed by using various CVD methods in which a film is formed in a reduced-pressure state, such as a CVD method (a chemical vapor deposition method) and an ICP-CVD method (an inductively-coupled plasma method). If ICP-CVD method is used, it is possible to form a film relatively fast.

FIG. 5 (PROCESS C) shows a forming process of the FP side dielectric layer 7. A detailed explanation of a CVD device 31 is simplified. An oxygen gas, which is heated in plasma at a high temperature to be activated, reaches to near a panel by diffusion. Since the activated oxygen gas reacts with a TEOS vaporized gas, a SiO₂ film is formed on the front panel glass 10. By selecting conditions such as a pressure and an oxygen gas flow rate in a chamber, and a supply of the TEOS vaporized gas properly, the FP side dielectric layer 7 composed of a SiO₂ film having a predetermined dense and thin thickness at a high film forming speed of about 2.5 μm/min.

The FP side dielectric layer 7 is formed at a relatively low heating temperature of a panel in a range of an ambient temperature to 300° C. inclusive. Because of this, a dielectric layer having a dense and high-voltage endurance characteristic can be manufactured fast even though a film is thin. In addition, there is an advantage that a warp and a crack do not occur in the front panel FP because a calcinations process is not performed.

It is preferable that the FP side dielectric layer 7 finally includes 80% to 100% of SiO₂. By increasing the rate, the FP side dielectric layer 7 that is denser and has high dielectric strength voltage can be obtained. As a general characteristic of a dielectric layer, if the high dielectric strength voltage being equal to or higher than 1.0×10⁶ V/cm is ensured and a dielectric constant ∈ is set in a range of 2 to 5 inclusive, the voltage endurance can be maintained highly even though a thickness of the FP side dielectric layer 7 is in a range of 1 μm to 10 μm inclusive. Therefore, if the FP side dielectric layer 7 becomes thinner, the discharge inception voltage and the electric power consumption are decreased. As a result, an excellent luminous efficiency can be realized.

By the above-mentioned method, the FP side dielectric layer 7 is formed.

Here, in the present invention, the FP side dielectric layer 7 is required not to be exposed to the atmosphere until the protective layer 8 is formed. Therefore, as shown in FIG. 4, FIG. 5 (PROCESS C) and (PROCESS D), the front panel glass 10, on which the FP side dielectric layer 7 is formed, is moved from the CVD device 31 to a next vacuum film forming device 32 through a passage 33 that has been adjusted to a reduced-pressure atmosphere in advance. Also, the FP side dielectric layer 7 is temporarily stored under the condition if necessary. As an atmosphere at this time, it is preferable to fill with an inactive gas such as N₂ and Ar, and set the pressure at equal to or lower than 100 kPa, or equal to or lower than 0.13 Pa preferably.

### <Formation of Protective Layer>

Next, a protective layer is formed on a main surface of a dielectric layer (S4).

More specifically, as shown in FIGS. 4 and 5 (PROCESS B) by using the vacuum film forming process method such as the electron beam evaporation method, the sputtering method, and the like, a material including MgO as metal oxide is formed on the main surface of the dielectric layer, in the vacuum film forming device 32 whose inside is adjusted to a reduced-pressure atmosphere. As a sputtering gas, an Ar gas and the like is used.

Note that “vacuum film forming process” is a process in which a thin film is formed in a vacuum state. The vacuum film forming process includes the vacuum evaporation method, the plasma beam evaporation method, and the various CVD methods and the like as well as the electron beam evaporation method and the sputtering method, and can be used for forming a protective layer at a low temperature. By using the vacuum film forming process, a protective layer is formed while being prevented from exposing to the atmosphere as well as the dielectric layer. Therefore, a high quality protective layer can be formed stably. Also, by performing the vacuum film forming process method at a relatively low temperature, a warp and a crack of a panel occurring in a general high-temperature process is prevented.

In the above-mentioned process, a film is formed at a thickness of 0.4 μm to 1 μm of right after the manufacturing. Since the protective layer 8 is composed of MgO, the protective layer 8 having an excellent secondary electron emission coefficient, high transparency and an anti-sputtering characteristic can be formed.

Note that a material other than MgO can be used for the protective layer 8. For example, the protective layer 8 composed of other metal oxide such as CaO, BaO, SrO, MgNO, ZnO and the like is also usable.

By the above-mentioned method, the front panel FP is completed.

Note that the front panel FP is stored under a reduced-pressure atmosphere without being exposed to the atmosphere until a next sealing process ends in the first embodiment.

The front panel FP is not exposed to the atmosphere until the sealing process ends (S1 to S4). Therefore, moisture and an impure gas caused by the atmosphere are prevented from attaching the protective layer 8 and the dielectric layer. As a result, the protective layer 8 can keep a state in which the performance right after the film forming (secondary electron emission efficiency, an anti-sputtering characteristic, and the like) is maintained highly, and the reliability of luminous efficiency and the like is not lost. By forming the display electrode 4, the FP side dielectric layer 7, and the protective layer 8 under a reduced-pressure atmosphere, these can be composed as dense thin film structures, and excellent voltage endurance and luminous efficiency can be obtained.

Note that the dense thin film structure having the above-mentioned effects is also composed in the data electrode 12 and the BP side dielectric layer 13 of the following back panel BP.

### <Manufacturing of Back Panel>

Next, the manufacturing of the back panel BP will be described (S5 to S9). In the same manner as the front panel FP, the back panel BP is managed under a reduced-pressure atmosphere without being exposed to the atmosphere until the sealing process ends.

FIG. 6 is a cross section showing a forming process of the back panel BP in a manufacturing method of a PDP.

As shown in FIG. 6 (PROCESS A), a metal electrode material including an Al—Nd metal material is used for a main surface of the back panel glass 11. In the same manner as the bus electrode, the plurality of the data electrodes 12 composed of Al—Nd alloy thin film are formed at a low temperature by performing a desired patterning using the vacuum film forming process method and the dry etching method (S5).

Although the data electrode 12 is formed by an Al—Nd metal material in a vacuum state, the data electrode 12 may be formed by calcining after applying an Ag paste, or composed as a laminated structure of Cr/Cu/Cr.

Next, the BP side dielectric layer 13 is formed at a thickness of about 2 μm of right after the manufacturing for covering the data electrode 12 (S6).

More specifically, as shown in FIG. 6 (PROCESS B), the back panel glass 11 on which the plurality of the data electrodes 12 are formed is carried into a CVD device 41. Then, the BP side dielectric layer 13 is formed as well as the FP side dielectric layer 7 based on the CVD method, the plasma CVD method, or the ICP-CVD method.

Here, in the present invention, the back panel BP is continuously managed in a vacuum state or under a reduced-pressure atmosphere in the dielectric layer forming step (S6), a barrier rib forming step (S7), and while the panel is moved and stored. This prevents moisture and an impure gas caused by the atmosphere from attaching to the protective layer 8.

Note that the BP side dielectric layer 13 may be formed by calcining after applying a low-melting glass by printing in a conventional way.

Then, as shown in FIG. 6 (PROCESS C), a plurality of barrier ribs are formed for each of the data electrodes 12 along a drawing direction (S7). A non-lead-based glass material can be used for the barrier rib and the material is applied to the main surface of the panel as a paste, then calcining is performed. At this time, the barrier rib can be formed into stripes or a curb shape by a known predetermined patterning is performed.

When the plurality of barrier ribs are formed, a phosphor layer is formed between each of the barrier ribs as shown in FIG. 6 (PROCESS D). More specifically, phosphor powders such as (Y, Gd) BO₃: Eu, Zn₂SiO₄: Mn, and BaMg₂Al₁₄O₂₄: Eu and the like are used for materials of each color red, green, and blue. The phosphor powders are mixed with an organic solvent such as a-terpineol, ethyl cellulose, and the like, and the viscosity is controlled to make a phosphor ink. After this, the phosphor ink is applied between each of the barrier ribs by using a line jet method and the like. Then, a calcining process is performed at about 500° C. to form the phosphor layer (S8).

Next, as shown in FIG. 6 (PROCESS E), a material of the sealing layer is applied on the entire peripheral portion of the main surface of the back panel BP on which the barrier ribs 14 and the phosphor layer 15 are formed (S9). The material is applied at least one fold (preferably two fold) by using a dispenser.

In a third embodiment, as the sealing layer 17, an inner applied sealing layer 1711 and an outer applied sealing layer 1721 are formed doubly on the entire peripheral portion of the main surface of the back panel BP. As a sealing material, a material having a high airtight characteristic is applied to the inner applied sealing layer 1711, and a material having a high strength characteristic is applied to the outer applied sealing layer 1721. Note that the material having a high airtight characteristic may be applied to the outer applied sealing layer 1721, and a material having a high strength characteristic may be applied to the inner applied sealing layer 1711.

As a material of the sealing layer 17, at least one material selected from the group consisting of an organic resin material, an inorganic material, and a metal material can be used. It is preferable to use a composite material including a mixture of at least two materials out of an organic resin material, an inorganic material, and a metal material. More specifically, the sealing layer 17 is composed of a composite material including about 70 wt % of a silica component as a main component and an epoxy resin material. Note that it is preferable not to add a xylene component.

As a material of a high-airtight enclosing layer (a material of the applied sealing layer 1711), the following material can be used. The material is made by adding acrylate ultraviolet cure adhesive and cation-cure type ultraviolet cure epoxy resin adhesive to a fine particle and a whisker material made by mixing inorganic materials such as SiO₂, glass, metal nitride, metal carbide, and the like.

On the other hand, as a material of a high-strength enclosing layer (a material of the applied sealing layer 1721), a material that slightly decreases an inorganic material from the material of the high-airtight enclosing layer.

By the above-mentioned method, the back panel BP is completed.

### [From Sealing Process to Completion]

FIG. 7 is across section showing a sealing and enclosing process and the like (S10 to S12) in a manufacturing method of a PDP of the present invention.

Firstly, as shown in FIG. 7 (PROCESS A), the front panel FP and the back panel BP managed under a reduced-pressure atmosphere are transported to a vacuum package room 72 that is in a vacuum state or a reduced-pressure state in a chamber 70 through a passage 71 that is in a vacuum state or a reduced-pressure state (100 kPa to 0.13 Pa).

Next, an inside of the chamber 70 is evacuated to a certain level. Then, the inside of the chamber 70 is replaced with a discharge gas composed of a mixed gas including a Xe—Ne rare gas (S10). After this, the vacuum package room 72 is opened, and the front panel FP is transported to an assembling and gluing process shown in FIG. 7 (PROCESS B) without being exposed to the atmosphere. As shown in FIG. 7 (PROCESS B), in the chamber 70 that is replaced with the discharge gas, the front panel FP and the backpanel BP are arranged in opposing to each other with a plurality of barrier ribs in between. Then, the front panel FP and the back panel BP are assembled and glued together (S11).

In a discharge gas at a predetermined pressure (about 60 kPa in the first embodiment), as shown in FIG. 7 (PROCESS C), an ultraviolet ray (UV light) is radiated from an outside or an inside of the chamber 70 to the applied sealing layers 1711 and 1721 arranged on the entire peripheral portions of the main surfaces of the front panel FP and the back panel BP. The applied sealing layers 1711 and 1721 are cured by this ultraviolet cure adhesion method, and the double sealing layer 17 composed of a first enclosing layer 171 and a second enclosing layer 172 is formed to seal and enclose the front panel FP and the back panel BP (S12).

Other than the above-mentioned method, the front panel FP and the back panel BP may be sealed by the enclosing layers using a method including at least one method out of a heating adhesion method, an ultraviolet cure method, a laser ablation method, and an ultrasonic welding method. Depending on a sealing layer material, the performance of the sealing layer is improved by performing the ultraviolet cure and heating at the same time.

When the double sealing layer 17 is provided, firstly, an inner sealing layer material is applied and then, the inner sealing layer material is cured to enclose the front panel FP and the back panel BP. After this, an outer sealing layer material is applied and cured. It is preferable to apply the outer sealing layer material so as to encompass the entire peripheral portions of the main surfaces of the front panel FP and the back panel BP because much higher airtight characteristic and strength characteristic can be expected.

As mentioned above, in the present invention, a discharge gas is enclosed at the same time as the front panel FP and the back panel BP are sealed by the sealing layer in a condition in which a discharge gas is enclosed between the front panel FP and the back panel BP in the chamber 70. By using this method, there is no need to arrange a tip tube and the like in a PDP, and an extremely flat and smart PDP can be manufactured.

Also, by using the above-mentioned method, a discharge gas is enclosed in the front panel FP and the back panel BP and a sealing process is performed without being exposed to the atmosphere under a reduced-pressure atmosphere. Therefore, there is no adsorption of an impure gas caused by the atmosphere. Moreover, by performing a sealing process at a low temperature, a carbon gas caused by the sealing layer 17 is prevented from occurring in the sealing process. This prevents the BP side dielectric layer 13 and the protective layer 8 from being deteriorated because of an impure gas as much as possible. As a result, high luminous efficiency and reliability can be maintained for an extended period.

When the sealing process (S12) is performed under a reduced-pressure atmosphere at an ambient temperature, there is a case in which it is preferable to perform a heating treatment to some extent depending on a type of a sealing layer material used in the sealing process. In this case, the heating process can be supplementary performed in a chamber. Or, by performing a heating process at a low temperature (about 100° C.) in an aging process and the like that is performed after the sealing process, an adhesive strength can be increased.

In the above-mentioned process, the sealing layer materials arranged on the entire peripheral portions of the main surfaces of the front panel FP and the back panel BP are calcined at a low temperature, and a calcining gas is eliminated from the whole of the front panel FP and the back panel BP. Therefore, a gas can be remarkably eliminated at a high speed compared with a conventional technology in which a tip tube is used. Also, since there is no need to provide a tip tube in a panel, there is no mark of a tip tube in appearance and a flat and smart PDP can be manufactured.

In the first embodiment, since calcining is performed at a low temperature, an unnecessary gas (carbon dioxide), which occurs at a high temperature and needs to be eliminated, is unlikely to occur. In a glass frit used in a conventional sealing process, calcining needs to be performed at a temperature of about 450° C. As a result, an organic component caused by the glass frit such as a binder and the like causes an unnecessary chemical reaction, and an unnecessary impure gas is likely to remain inside of a PDP. On the other hand, in the first embodiment, a sealing layer contains a silica component as a main component and an epoxy resin material. This enables a sealing process to be performed at a low calcining temperature in a range of an ambient temperature to about 300° C. inclusive. As a result, the unnecessary chemical reaction can be prevented and a carbon dioxide gas volume that needs to be eliminated can be remarkably decreased.

The present invention is not limited to a construction in which a panel glass is used as described in the above-mentioned PDP. For example, a material other than a glass material (such as a plastic panel) may be used for a PDP. When a plastic panel is used for a front panel and a back panel, entire peripheral portions of main surfaces of the front panel and the back panel can be enclosed using the ultrasonic welding method in a sealing process.

The discharge gas replacement (S10), the assembling and gluing process (S11), and the sealing process (S12) are performed continuously with keeping a reduced-pressure atmosphere.

After performing the above-mentioned processes, an aging process (S13) is performed to complete the PDP.

If a sealing process is performed by the heating adhesion method, there is a case in which it is better to perform a heating treatment supplementary in addition to a sealing process depending on a material option of a sealing layer. In this case, it is preferable to continuously perform heating adhesion supplementary in the aging process.

### Modification of the First Embodiment

The following describes one construction example (FIG. 2) in a case in which a metal material is used for the sealing layer 17. A feature of a PDP shown in FIG. 2 is that a metal layer 173 is arranged between glass frit layers 174 that are provided on the sealing layer 17 in a direction of a panel thickness.

The glass frit layers 174 are composed of a material including a low-melting glass composition that is the same as a conventional technology, and are fixed to the entire peripheral portions of the main surfaces of the front panel FP and the back panel BP in advance before a sealing process. The used amount of the material is smaller than a conventional sealing layer because a purpose of the material is to fix the metal layer 173 to the glass frit layers 174. This decreases carbon dioxide caused by a glass frit.

The metal layer 173 is formed as a layer having a U-shaped cross section in a direction of a panel cross section. As a material of the metal layer 173, in order to maintain a sealing characteristic, a material having a same thermal expansion coefficient as the panel glasses FP and BP or a characteristic based on the panel glasses FP and BP is preferable. Here, the metal layer 173 is composed of a 42% Ni-6% Cr-42% Fe metal material as one example. A composition of the metal layer 173 is not limited to the above-mentioned composition.

A forming method of the sealing layer 17 is same as the manufacturing method of the first embodiment on the whole. However, a metal material having a L-shaped cross section is laminated on each of the glass frit layers of the front panel FP and the back panel BP before a sealing process. Then, the metal material is arranged in opposing to each other, and the front panel FP and the back panel BP are arranged in opposing to each other, the metal material is adhered by melting by radiating a laser from an outside.

A PDP with this construction has the same effect as the PDP1 shown in FIG. 1. In addition, an impure gas can be prevented from occurring when the front panel FP and the back panel BP are sealed as much as possible because the sealing process is performed by melting a metal and a used material of a low-melting glass amount is small. This prevents the protective layer 8, the FP side dielectric layer 7, and the BP side dielectric layer 13 from being deteriorated, and high reliability of a PDP can be obtained.

An example of arranging a single sealing layer is shown in FIG. 2. However, the present invention is not limited to the single layer, and more than double sealing layer may be arranged.

### Second Embodiment

FIG. 3 is a cross section showing a construction of a PDP of a second embodiment.

A feature of the second embodiment is that the double sealing layer 17 is composed of a first enclosing layer 176 and a second enclosing layer 177, and an outer sealing layer (the second enclosing layer) is composed of two different thin film layers 1771 and 1772 that are laminated alternately in a direction of a panel thickness.

The first enclosing layer 176 is composed of a material having a high airtight characteristic that is described in the first embodiment.

On the other hand, the thin film layers 1771 and 1772 are composed of two different materials out of an organic material, an inorganic material. The second enclosing layer 177 having a multi-layer film structure has a higher airtight characteristic than that of a normal enclosing layer composed of only an organic adhesion layer and the like. Therefore, the second enclosing layer 177 is impervious to water and an oxygen gas, and has an advantage as a PDP. Here, as shown in FIG. 3, it is preferable to arrange the second enclosing layer 177 in a laminated multilayer film so as to encompass at least one panel of the front panel FP and the back panel BP from an outer circumference (so that the second enclosing layer 177 protrudes from the panel peripheral portion in a L-shaped cross section) in terms of an improvement of a panel airtight characteristic.

The second enclosing layer 177 is formed by the following way after the first enclosing layer 176 is formed under a reduced-pressure atmosphere in the same manner as the first embodiment.

If the second enclosing layer 177 is formed as a laminated structure of the metal thin film layer 1771 composed of an Al material and the organic resin layer 1772, firstly, an Al thin film is formed using a sputtering method under a reduced-pressure atmosphere. Then, an organic resin layer is formed on the Al thin film using a plasma polymerization method, and this process is repeated alternately. Although the number of laminated layers depends on a layer film thickness, it is preferable to be about 100 layers if the layer film thickness is a few μm.

In the PDP1 having the above-mentioned construction of the second embodiment, the protective layer 8, the dielectric layers 7 and 13 are prevented from being deteriorated, and excellent reliability and sealing characteristic can be obtained by making a front panel FP and a back panel BP without being exposed to the atmosphere and by continuously performing a sealing process at a low temperature in the same manner as the first embodiment. Also, when the PDP is sealed, there is no need to use a tip tube. Therefore, a flat and smart PDP can be realized.

The second enclosing layer 177 is not damaged easily even if a panel is bent to some extent in a direction of a panel thickness because of a laminated structure, and has a high airtight characteristic. This improves reliability and a sealing characteristic. Therefore, the second enclosing layer 177 is suitable for a PDP providing a flexible plastic panel and the like instead of a panel glass such as the panel glasses 10 and 11.

### Third Embodiment

FIG. 8 shows a construction of a PDP101a of a third embodiment. FIG. 8A is a cross section of the PDP101a in a thickness direction, and FIG. 8B is a front view of the PDP101a.

The third embodiment is different from the first and second embodiments in that in a sealing layer 18a, which is arranged on entire peripheral portions of main surfaces of a front panel FP and a back panel BP, a most external peripheral portion has a construction in which an adhesion layer 181a, a seal layer 182a, and an adhesion layer 183a are laminated in this order along a panel thickness direction. On the other hand, an inside area surrounded by the trilaminar structure is composed as an integrated adhesion layer 184a.

The front panel FP and the back panel BP is sealed by the sealing layer 18a under a reduced-pressure atmosphere in which a discharge gas is filled in a chamber when a sealing process is performed in the same manner as the first and the second embodiments.

The adhesion layers 181a, 183a, and 184a are composed of a sealing layer material that has a high airtight characteristic same as the sealing layer described in the first embodiment, and also composed of a material that does not include a binder component. Also, the adhesion layers 181a, 183a, and 184a are formed by applying, with a seal layer material in between, using a printing method and the like as a part of an enclosing layer of the sealing layer 18a before a sealing process. With this construction, a sealing process can be performed relatively easily at a low temperature in a range of an ambient temperature to 300° C. inclusive, and a sealing layer having excellent sealing performance can be realized. Note that the sealing can be performed by curing an adhesion layer using a method including at least one method out of the heating adhesion method, the ultraviolet cure adhesion method, the laser weld method, and the ultrasonic welding method.

On the other hand, the seal layer 182a is composed of a material that does not actually include a binder component (about 70 wt % of a silica component as a main component) and some amount of an organic resin material (such as epoxy, acrylate and the like). Compared with the adhesion layers 181a, 183a, and 184a, the seal layer 182a has a higher airtight characteristic that can seal more discharge gas in an internal space between the front panel FP and the back panel BP, and prevent an outer oxygen gas, carbon dioxide, and an organic solvent volatile gas caused by the adhesion layers 181a, 183a, and 184a from being flowed into the internal space.

More specifically, the seal layer 182a may be composed of a vacuum packing material, an elastic material such as a rubber material and the like, or a packing material including a metal material such as Al and Cu and the like. With this construction, a high airtight sealing characteristic can be realized when a discharge gas is lower pressure than the atmosphere.

The PDP101a having the above-mentioned construction of the third embodiment can have about the same effects as the first and second embodiments. As a result of evaluating the reliability of the PDP based on the third embodiment, the luminous efficiency is improved by decreasing a discharge starting voltage compared with a conventional PDP that is glued together and assembled while a front panel FP and a back panel BP are exposed to the atmosphere. Moreover, the PDP can have a longer operating life while maintaining the higher luminous efficiency than a conventional PDP that is manufactured in a conventional sealing process in which a PDP is sealed while being exposed to the atmosphere.

Although an organic material such as an epoxy resin and the like is used for a material of a seal layer in the third embodiment, an impure gas caused by the organic resin material is unlikely to occur because a little amount of the organic material (less than 30 wt %) is used by being added to an inorganic material such as a silica material. Therefore, the organic material such as the epoxy resin and the like does not cause a problem of an impure gas of the present invention.

### Fourth Embodiment

FIG. 9 is a cross section showing a construction of a PDP102a of a fourth embodiment. The fourth embodiment is different from the third embodiment in that an adhesion layer is formed uniformly in a most external peripheral portion of a sealing layer 28a as shown in FIG. 9, and a trilaminar structure composed of a seal layer 281a, an adhesion layer 282a, and a seal layer 283a is sandwiched between adhesion layers 284a along main surfaces of a front panel FP and a back panel BP. The sealing layer 28a is formed by laminating a material using a printing method and the like before a sealing process in the same manner as the third embodiment.

With this construction, the fourth embodiment can have the same effect as the third embodiment, and an inside enclosing characteristic can be improved.

Since the seal layer 283a is formed in inner peripheral portions of the front panel FP and the back panel BP in the fourth embodiment, an oxygen gas and a carbon dioxide gas from an outside of the front panel FP and the back panel BP can be prevented from being mixed, or a carbon dioxide gas caused by the adhesion layers 282a and 284a during a sealing process can be prevented from being flowed in an internal space between the front panel FP and the back panel BP effectively.

### Fifth Embodiment

FIG. 10 is a cross section showing a construction of a PDP103a of a fifth embodiment. A feature of the fifth embodiment is that in a sealing layer 38a, a seal layer 381a, an adhesion layer 382a, and a seal layer 383a are laminated along a panel thickness direction as a trilaminar structure, and the trilaminar structure is provided doubly along main surfaces of a front panel FP and a back panel BP.

With this construction, the fifth embodiment can have the same effects as that of the third and fourth embodiments. In addition, an adhesion area of the sealing layer 38a to the panel surface increases because the adhesion layer 382a is sandwiched between the seal layer 381a and the seal layer 383a, and arranged in a plurality of portions of the main surfaces of a front panel FP and the back panel BP. Therefore, an adhesive strength can be improved.

### Sixth Embodiment

FIG. 11 is a cross section showing a construction of a PDP104a of a sixth embodiment. Although the sixth embodiment is about the same as the fifth embodiment, a feature of the sixth embodiment is that a sealing layer 48a has a construction in which an adhesion layer 384a in a most external peripheral portion of the sealing layer 38a is omitted. If a sealing characteristic can be obtained without forming many sealing layers because a PDP size is relatively small and the like, the same effects as that of the third to fifth embodiments can be obtained even though an adhesion layer in a most external peripheral portion is omitted.

### Seventh Embodiment

FIG. 12 is a cross section showing a construction of a PDP105a of a seventh embodiment. A feature of the seventh embodiment is that a most external peripheral portion of a sealing layer 58a is composed of an adhesion layer 585a that is continuously formed on entire peripheral portions of main surfaces of a front panel FP and a back panel BP in a panel thickness direction.

In other words, as shown in FIG. 12, the sealing layer 58a of the PDP105a has a trilaminar structure composed of an adhesion layer 581a, a seal layer 582a, and an adhesion layer 583a, and is formed in two portions (can be formed in a plurality of portions more than one) in a width direction of the sealing layer 58a. Also, the adhesion layer 585a is formed and arranged continuously and uniformly in most external peripheral portions of the front panel FP and the back panel BP. A shape of the sealing layer 58a can be set in advance by laminating and arranging each material in the same manner as the third embodiment before a sealing process.

On the other hand, a layer in a most internal peripheral portions of the front panel FP and the back panel BP in a width direction of the sealing layer 58a is a seal layer 584a that is formed continuously from the seal layer 582a.

Note that the sealing layer 58a may be formed in one fold in a width direction along main surfaces of the front panel FP and the back panel BP, and may be formed doubly.

With this construction, the seventh embodiment can have the same effects of the third to sixth embodiments, and an adhesion area along the main surfaces of the front panel FP and the back panel BP of the sealing layer 58a remarkably increases. Therefore, a sealing process can be performed with keeping a high adhesive strength.

### Eighth Embodiment

FIG. 13 is a cross section showing a construction of a PDP106a of an eighth embodiment. Although the eighth embodiment is about the same as the seventh embodiment on the whole, the eighth embodiment has a feature that a void portion 686 exists in a sealing layer 68a along the main surfaces of the front panel and the back panel, and the void portion 686 is contactless with any of an outside and the discharge space. As one example of this, in FIG. 13, the void portion 686 exists in a middle portion along the main surfaces of the front panel and the back panel.

With this construction, the eighth embodiment can have the same effect as that of the seventh embodiment. Even if a size of the sealing layer 68a becomes larger because of the void portion 686, a whole density of the sealing layer 68a does not increase so much. This enables the weight of a whole PDP to be reduced.

### Ninth Embodiments

FIG. 14 is a front view showing a construction of a PDP107a of a ninth embodiment. As shown in FIG. 14, a feature of the ninth embodiment is that in a single sealing layer 17a that is uniformly arranged on entire peripheral portions of a front panel FP and a back panel BP of the PDP107a by a seal layer 784a composed of a high airtight layer, a sealing layers 78a having a trilaminar structure composed of an adhesion layer 781a, a seal layer 782a, and an adhesion layer 783a are arranged in areas corresponding to four corners of the single sealing layer 17a.

With this construction, the ninth embodiment can have the same effect as that of the eighth embodiment, and the use of an adhesion layer material is remarkably reduced on the whole because the adhesion layers 781a and 783a are used only for the limited areas of the four corners of the front panel FP and the back panel BP. Therefore, an impure gas caused by a binder component such as an unnecessary carbon dioxide gas and the like can be prevented from occurring in a sealing process, and a dielectric layer and a protective layer can be maintained in a good condition.

The sealing layers 78a can be formed by laminating each material of the adhesion layer 781a, the seal layer 782a, and the adhesion layer 783a before a sealing process.

Note that the present invention is not limited to the example that the sealing layers 78a are arranged in the four corners of the front panel FP and the back panel BP. The sealing layers 78a may be arranged in at least one portion of the entire peripheral portions of the main surfaces of the front panel FP and the back panel BP.

For example, a sealing adhesion part having three layers composed of the adhesion layers 282 (382)a, the seal layers 283 (383)a, and the adhesion layers 281(381)a in the fourth and fifth embodiments may be arranged in a plurality of portions of the entire peripheral portions of the main surfaces of the front panel FP and the back panel BP as the sealing layer 17a in FIG. 14. Also, other combination may be practicable.

### Tenth Embodiment

### 111. Construction of PDP

FIG. 15 shows a construction of a PDP201b of a tenth embodiment. FIG. 15A is a front view of a back panel 20b, and FIG. 15B is a cross section of a PDP.

The PDP201b shown in FIG. 15 basically has the following construction. A front panel glass 11b having a display electrode 12b on a facing surface and a back panel glass 21b having a data electrode 22b on a facing surface are overlapped at a certain gap so that the display electrode 12b and the data electrode 22b at right angles to each other interspatially. Then, the front panel glass 11b and the back panel glass 21b are sealed in a state in which a discharge space 26b is depressurized via a gasket layer 1b provided on entire peripheral portions of main surfaces of the panel glasses 11b and 21b, and a sealing layer 2b provided so as to surround the gasket layer 1b. In the FIG. 15, a barrier rib 24b and a phosphor layer 25b are simply illustrated.

As a material of the gasket layer 1b, a metal material composed of at least one material selected from the group consisting of Cu, Al, Zn, Ag, and In can be used.

As a material of the sealing layer 2b, a thermosetting resin such as an epoxy resin and the like can be used.

As a result, in the tenth embodiment, in both of the panel glasses 11b and 21b, an excellent sealed state can be maintained because the compression force is transmitted near the gasket layer 1b by a stress resulting from a contractile effect when the sealing layer 2b is cured, and a differential pressure between the reduced-pressure discharge space 26b and the atmosphere.

Also, the PDP201b of the tenth embodiment has a feature that a sealing layer material composed of a glass frit such as a conventional sealing layer is not used, but the gasket layer 1b composed of a metal gasket is used. This prevents an impure gas from being flowed in the discharge space 26 in a sealing process in which a heating treatment is performed in a sealing device when a PDP is manufactured. In other words, in the PDP201b of the tenth embodiment, since a metal gasket such as Cu, Al, Zn, Ag or the like is exposed to the discharge space 26, an impure gas is not emitted from a metal material even if a sealing process is performed at a high temperature such as several hundreds degrees centigrade. As a result, a dielectric layer and a protective layer can be maintained in a favorable condition.

Note that as the gasket material, a gasket material such as black lead, PTFE and the like other than metal can be used.

Although a thermosetting resin is used as a material of the sealing layer 2b in the tenth embodiment, a glass frit having a good wettability with a metal gasket may be used.

In this case, an impure gas can be prevented from being emitted from the glass frit to the discharge space 26b because a metal gasket is exposed to the discharge space 26b. This sealing construction excels in the matching of a thermal expansion coefficient of both of the panel glasses 11b, 21b, and a glass frit for sealing.

### (Relation Between Gasket Layer and Sealing Layer Thickness)

In the tenth embodiment, a layer having a double layer construction composed of the gasket layer 1b and the sealing layer 2b is used for a sealing method of the PDP201b. Here, a total thickness limitation of a gasket layer and a sealing layer that are provided on a PDP is restricted because of a size standard of a PDP and the like. Therefore, a combination of thicknesses of the gasket layer and the sealing layer becomes an issue.

The relation between materials of a gasket layer and a sealing layer, and a gasket layer thickness a and a sealing layer thickness b along main surfaces of a front panel FP and a back panel BP can be adjusted by the following way.

If the sealing layer thickness b is extended, an airtight characteristic can be improved because a sealing layer has a high airtight characteristic.

On the other hand, a gasket layer has a high strength characteristic because a metal material and the like is used for the gasket layer. Therefore, if the gasket layer thickness a is extended, a mechanical strength of a PDP can be improved. However, if a high sealing characteristic is required for a gasket layer, a soft metal material prompting the plastic deformation is required to be used when a sealing process is performed. This slightly reduces the mechanical strength performance.

Note that the balance between an airtight characteristic and a strength characteristic varies according to a PDP size. Therefore, it is preferable to set the gasket layer thickness a and the sealing layer thickness b along the main surfaces of the front panel FP and the back panel BP according to a size standard of a PDP that is actually manufactured.

### 11-2. Manufacturing Method of PDP

Here, a sealing process of the PDP201b of the tenth embodiment will be described.

FIG. 16 is a cross section of a sealing device 40b for sealing the PDP of the tenth embodiment. The sealing device 40b is composed of an atmosphere furnace 41b having a heater (not illustrated) that can heat to a temperature in a range of an ambient temperature to several hundreds degrees centigrade, a panel fixed base 42b, an exhaust pipe 44b connecting to a vacuum pump 43b, a gas supply line 46b connecting to a discharge gas supply cylinder 45b and the like.

FIG. 16A shows a state of the sealing device 40b in a mounting process that is performed before an exhausting process and a discharge gas introducing process. While the PDP201b is being manufactured, the back panel glass 21b is arranged on the panel fixed base 42b in the atmosphere furnace 41b with an electrode surface side up. Also, a metal gasket as the gasket layer 1b composed of Cu is arranged on the entire peripheral portion of the main surface of the back panel glass 21b.

On the other hand, as shown in FIG. 16, the front panel glass 11b with a metal block 47b is supported by a base frame (not illustrated) while being opposed to the back panel glass 21b. Then, the front panel glass 11b is arranged on the back panel glass 21b at a certain gap. Here, both of the panel glasses 11b and 21b are arranged so that each of main surfaces, on which the display electrode 12b and the data electrode 22b are formed, are opposed to each other. After this, an inside of the sealing device 40b is exhausted by the vacuum pump 43b. Then, a discharge gas is introduced from the discharge gas supply cylinder 45b to the inside of the sealing device 40b. Since an internal space between both of the panel glasses 11b and 21b is in an open state that is not airtight and a fluid resistance is low at this time, the high-speed exhaust and the high-speed introduction of a discharge gas can be realized.

As shown in FIG. 16B, the base frame (not illustrated) is moved downward, and the front panel glass 11b is lapped over the back panel glass 21b while alignment is performed so that the metal gasket is sandwiched between the front panel glass 11b and the back panel glass 21b. Then, the base frame is removed from the front panel glass 11b.

As a result, both of the panels are loaded uniformly because of the metal block 47b on an upper surface of the front panel glass 11b. Then, an epoxy resin as a sealing layer 2b is injected into a groove-like depression that is formed by the metal gasket and inner walls of both of the panel glasses 11b and 21b. After this, an inside of the sealing device 40b is heated to a curing temperature of an epoxy resin. The sealing process is performed as mentioned above, the PDP 201b having a construction in which a discharge gas is introduced into the discharge space 26b between both of the panel glasses 11b and 21b is completed.

FIG. 17 is another example of a sealing process of the PDP of the tenth embodiment, and shows a process when an ultraviolet cure resin (a sealing layer 3b) is used as a sealing layer.

In FIG. 17, an inside state of an atmosphere furnace in which the unfinished PDP201b is placed. In this example, after an exhausting process and a discharge gas introducing process are performed in the atmosphere furnace, the front panel glass 11b is lapped over the back panel glass 21b while alignment is performed so that a metal gasket as a gasket layer 1 arranged on the entire peripheral portion of the main surface of the back panel glass 21b is sandwiched between the front panel glass 11b and the back panel glass 21b.

As a result, both of the panels 11b and 21b are loaded uniformly because of the metal block 47b on the upper surface of the front panel glass 11b. Then, an ultraviolet cure resin as the sealing layer 3b is injected into a groove-like depression that is formed by the metal gasket in the entire peripheral portions of the main surfaces and inner walls of both of the panel glasses 11b and 21b. Then, an ultraviolet ray is radiated to the resin from a panel side for a predetermined time to cure the resin. The sealing process is performed as mentioned above.

At this time, if an ultraviolet cure resin that is cured by a ultraviolet ray having a long-wavelength of equal to or longer than 350 nm is used, light transmitted through the panel glasses can be contributed to the cure. As a result, uneven curing can be prevented.

Instead of the heater provided in the sealing device 40b in FIG. 16, a pair of ultraviolet ray lamps 48b is provided for radiating the entire peripheral portions of the main surfaces of both of the panels in FIG. 17. This method has the following features. There is no need to heat in order to cure the sealing layer 3b, the sealing layer 3b is cured by an ultraviolet ray at a high speed, alignment of both of the panels can be performed with accuracy because a temperature does not vary widely, and the like.

### Eleventh Embodiment

FIG. 18 shows a construction of a PDP 202b of an eleventh embodiment. FIG. 18A is a front view of a back panel BP, and FIG. 18B is a cross section of the PDP 202b.

The PDP 202b shown in FIG. 18 is different from the PDP of the tenth embodiment in that the gasket layer 1b is fitted into a groove-like depression 101b that is arranged on the entire peripheral portions of the main surfaces of both of the panel glasses 11b and 21b, and the panel glasses 11b and 21b are sealed by the gasket layer 11b and the sealing layer 2b that is arranged so as to surround the gasket layer 1b.

In both of the panel glasses 11b and 21b, a good sealed state can be maintained because the compression force is transmitted near the gasket layer 1b by a stress resulting from a contractile effect when the sealing layer 2b is cured, and a differential pressure between the reduced-pressure discharge space 26b and the atmosphere. In this case, since the gasket layer 1b is fixed in the groove-like depression 101b that is arranged on the entire peripheral portions of the main surfaces of the panel glasses 11b and 21b, the PDP 202b can be manufactured easily and the sealing performance can be improved.

### Twelfth Embodiment

FIG. 19 shows a construction of a PDP 203b of a twelfth embodiment. FIG. 19A is a front view of a back panel BP, and FIG. 19B is a cross section of the PDP 203b.

The PDP 203b shown in FIG. 19 is different from the PDP of the tenth embodiment in that the front panel glass 11b having a display electrode 12b on a facing surface and the back panel glass 21b having the data electrode 22b on a facing surface are overlapped at a certain gap so that the display electrode 12b and the data electrode 22b at right angles to each other interspatially. Then, the gasket layer 11b is fitted into the groove-like depression 101b that is arranged on the entire peripheral portions of the main surfaces of the panel glasses 11b and 21b, and the panel glasses 11b and 21b are sealed by the gasket layer 11b and the sealing layer 2b that is intermittently arranged so as to surround the gasket layer 1b.

In the twelfth embodiment, a function of the sealing layer 2b is only giving the compression force that maintains the pressure bonding of both of the panels, and a sealing function is not required. Therefore, there is no need to continuously arrange the sealing layer 2b on the entire peripheral portions, and the sealing layer 2b can be partially arranged only in a portion in which a necessary strength for maintaining the pressure bonding can be obtained. This reduces components of the sealing layer 2b and simplifies the process. As a result, a reduction of cost can be realized.

### Thirteenth Embodiment

FIG. 20A is a front view of a PDP 204b of a thirteenth embodiment, and FIG. 20B is a cross section of the PDP 204b.

A feature of the PDP 204b shown in FIG. 20 is that the front panel glass 11b having the display electrode 12b on a facing surface and the back panel glass 21b having the data electrode 22b on a facing surface are overlapped at a certain gap so that the gasket layer 1b arranged in the entire peripheral portions of the main surfaces of both of the panel glasses is sandwiched between the front panel glass 11b and the back panel glass 21b, and the display electrode 12b and the data electrode 22b at right angles to each other interspatially. Moreover, the front panel glass 11b and the back panel glass 21b are sealed solidly with each other by a binding device such as a clip 6b and the like that is arranged in a circumference part of the front panel glass 11b and the back panel glass 21b.

As the gasket layer 1b, a metal gasket composed of an metal material composed of at least one material selected from the group consisting of Cu, Al, Zn, Ag, and In is used. Both of the panels are fixed by the clip 6b having a U-shaped cross section while both of the panels are being bonded by pressure.

With this construction, an excellent sealed state of both of the panel glasses 11b and 21b can be maintained because the pressure bonding is performed on the metal gasket by the compression force caused by a differential pressure between the reduced-pressure discharge space 26b and the atmosphere in addition to the compression force caused by the clip 6b.

The PDP 204b of the thirteenth embodiment has an advantage that a sealing process can be performed at an ambient temperature because a heating treatment for melting and curing a sealing layer and a glass frit are not necessary because of the clip 6b as the binding device.

Also, a metal gasket such as Cu, Zn, or the like is exposed to the discharge space 26b, and a heating treatment for sealing is not required. Therefore, it is highly unlikely that an impure gas caused by a glass frit is mixed into the discharge space 26b.

Note that a frame having a U-shaped cross section and the like can be also used as the binding device as well as the clip. In this case, it is necessary to give the tension so that both of the panel glasses 11b and 21b are bonded by pressure when the binding device is fitted into both of the panel glasses 11b and 21b.

As the sealing process of the PDP of the thirteenth embodiment, the finished front panel FP and the back panel BP are put into an atmosphere furnace while being opposed to each other, and the atmosphere furnace is evacuated. Then, a discharge gas is introduced into the atmosphere furnace. At this time, the front panel FP and the back panel BP are manufactured without being exposed to the atmosphere in the same manner as the manufacturing method of the first embodiment.

After this, the front panel glass 11b is lapped over the back panel glass 21b while alignment is performed so that the gasket 1b is sandwiched between the front panel glass 11b and the back panel glass 21b, and both of the panels are loaded uniformly by the metal block on the upper surface of the front panel glass 11b. Then, the clip 6b as a binding device is fitted into four sides of both of the panel glasses 11b and 21b in the atmosphere furnace, and the PDP204b of the thirteenth embodiment is completed.

### INDUSTRIAL APPLICABILITY

The present invention can be used for a PDP such as a flat-screen television in a wide range of sizes from a small size to a large size, a high-definition television, a flat-screen information equipment terminal, or the like. In other words, the present invention can be used for an image equipment industry, an information equipment industry, an advertisement equipment industry, and other industries. Therefore, the present invention can have a great deal of potential in industry.

### BRIEF DESCRIPTION OF THE DRAWINGS

FIG. 1 shows a construction of a PDP of a first embodiment of the present invention.

FIG. 2 is a modification of a construction of a PDP of a first embodiment of the present invention.

FIG. 3 shows a construction of a PDP of a second embodiment of the present invention.

FIG. 4 is a flowchart showing a manufacturing process of a PDP of the present invention.

FIG. 5 shows a forming process of a front panel FP of a PDP of the present invention.

FIG. 6 shows a forming process of a back panel BP of a PDP of the present invention.

FIG. 7 shows a sealing and enclosing process of a PDP of the present invention.

FIG. 8 shows a construction of a PDP of a third embodiment of the present invention.

FIG. 9 shows a construction of a PDP of a fourth embodiment of the present invention.

FIG. 10 shows a construction of a PDP of a fifth embodiment of the present invention.

FIG. 11 shows a construction of a PDP of a sixth embodiment of the present invention.

FIG. 12 shows a construction of a PDP of a seventh embodiment of the present invention.

FIG. 13 shows a construction of a PDP of an eighth embodiment of the present invention.

FIG. 14 shows a construction of a PDP of a ninth embodiment of the present invention.

FIG. 15 shows a construction of a PDP of a tenth embodiment of the present invention.

FIG. 16 shows a manufacturing process of a PDP of a tenth embodiment of the present invention.

FIG. 17 shows a manufacturing process (an ultraviolet cure) of a PDP of a tenth embodiment of the present invention.

FIG. 18 shows a construction of a PDP of an eleventh embodiment of the present invention.

FIG. 19 shows a construction of a PDP of a twelfth embodiment of the present invention.

FIG. 20 shows a construction of a PDP of a thirteenth embodiment of the present invention.

FIG. 21 is a cross section showing a construction of a discharge cell as a discharge unit of a conventional AC surface discharge type PDP.

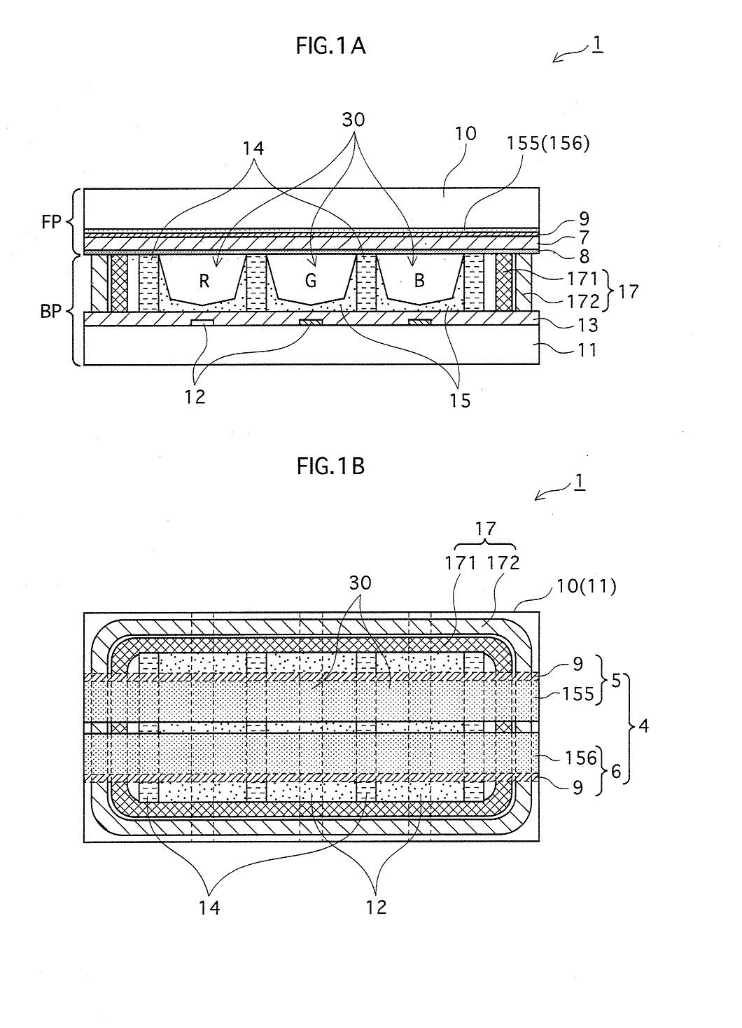

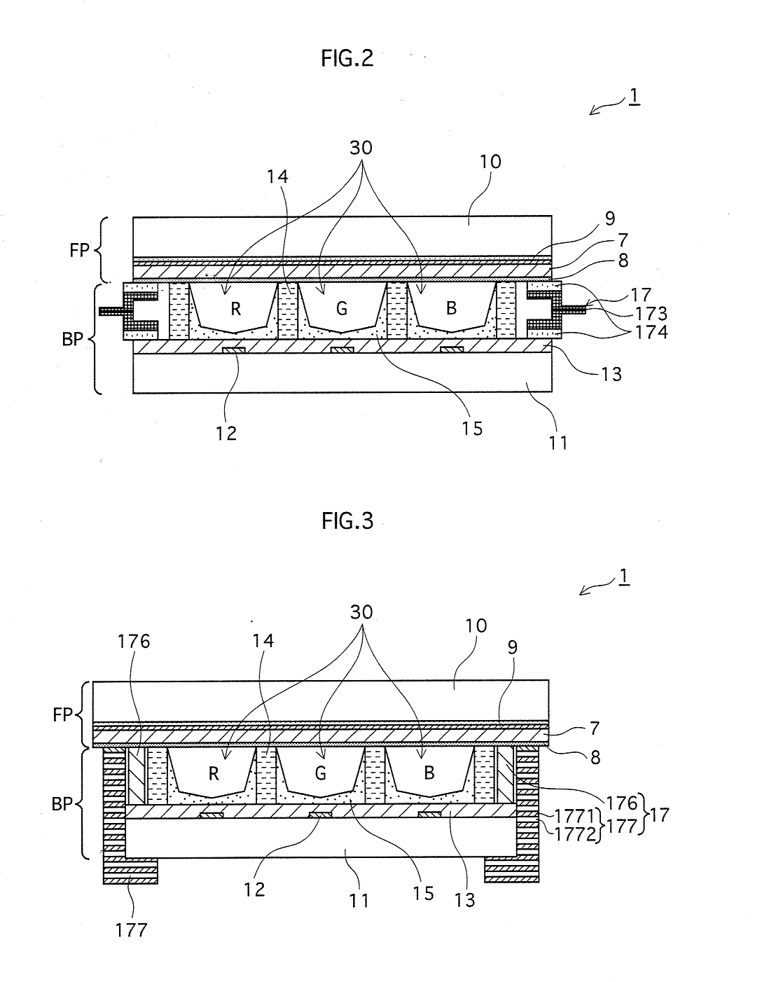

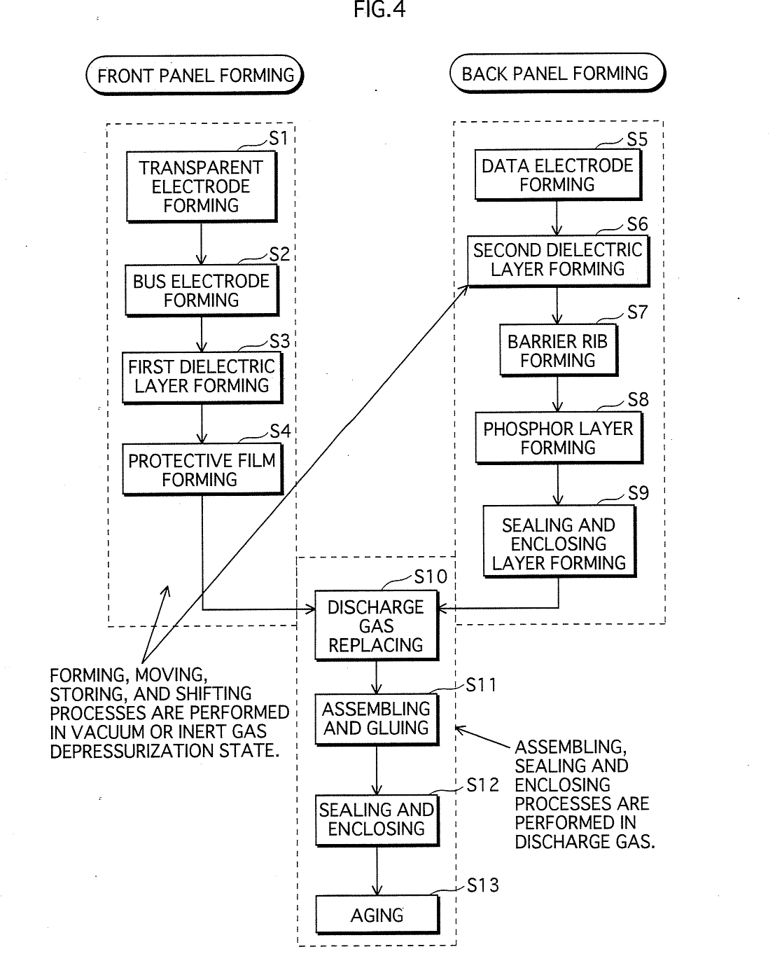

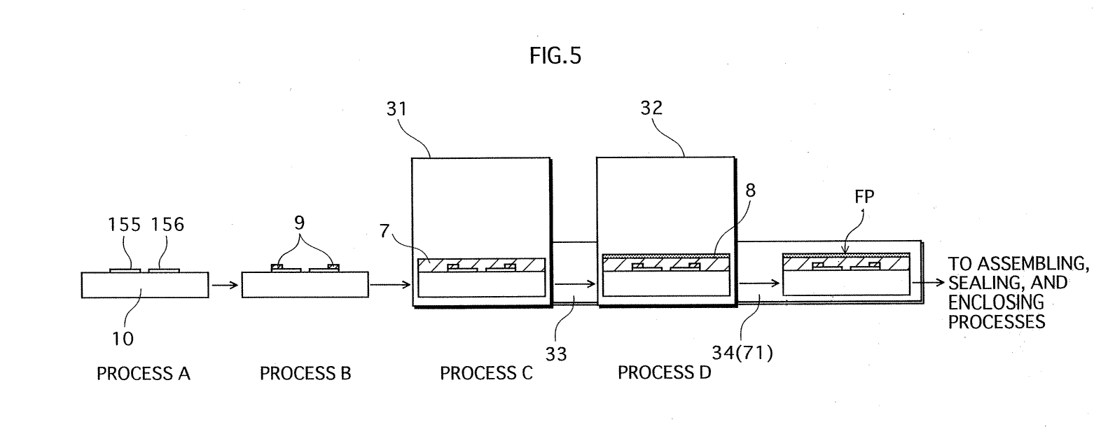

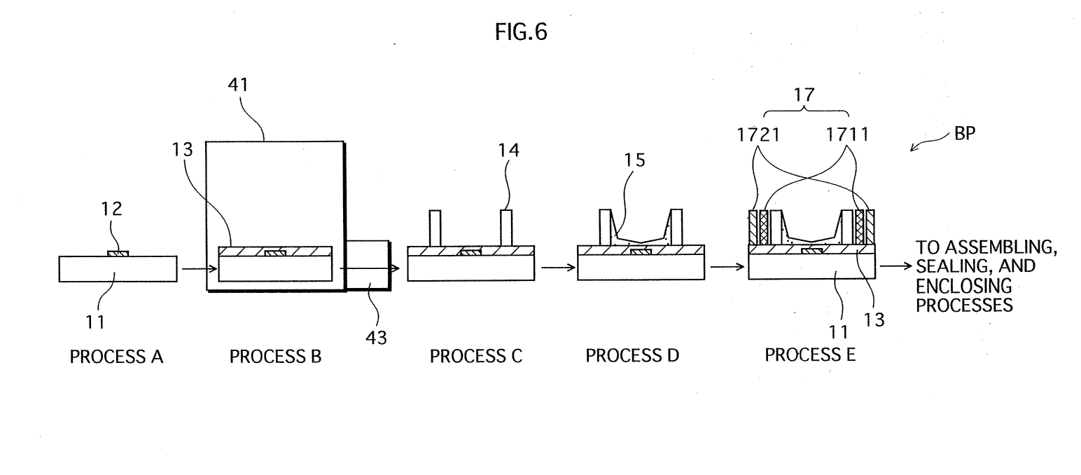

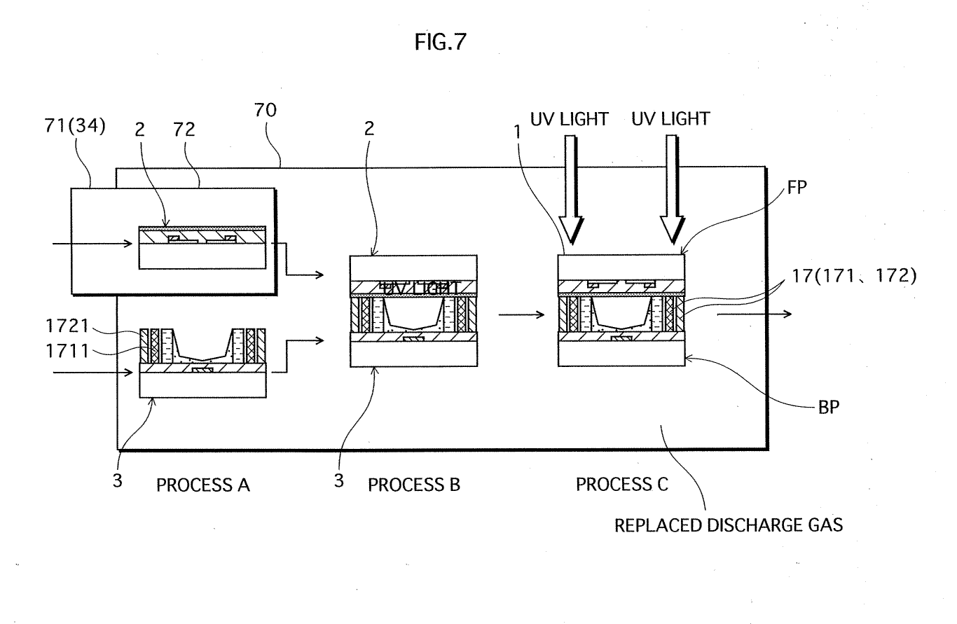

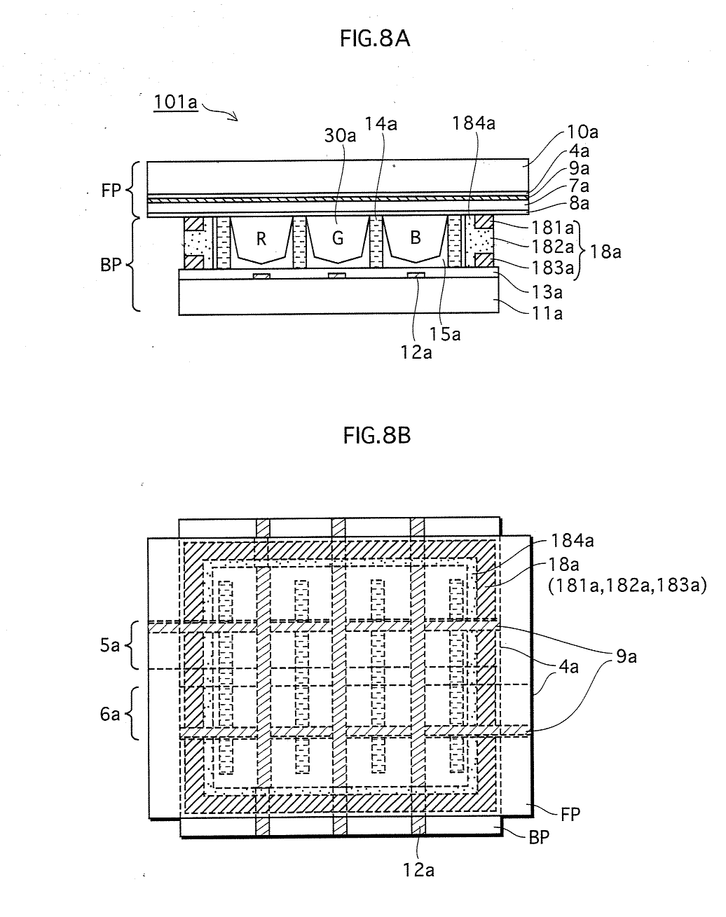

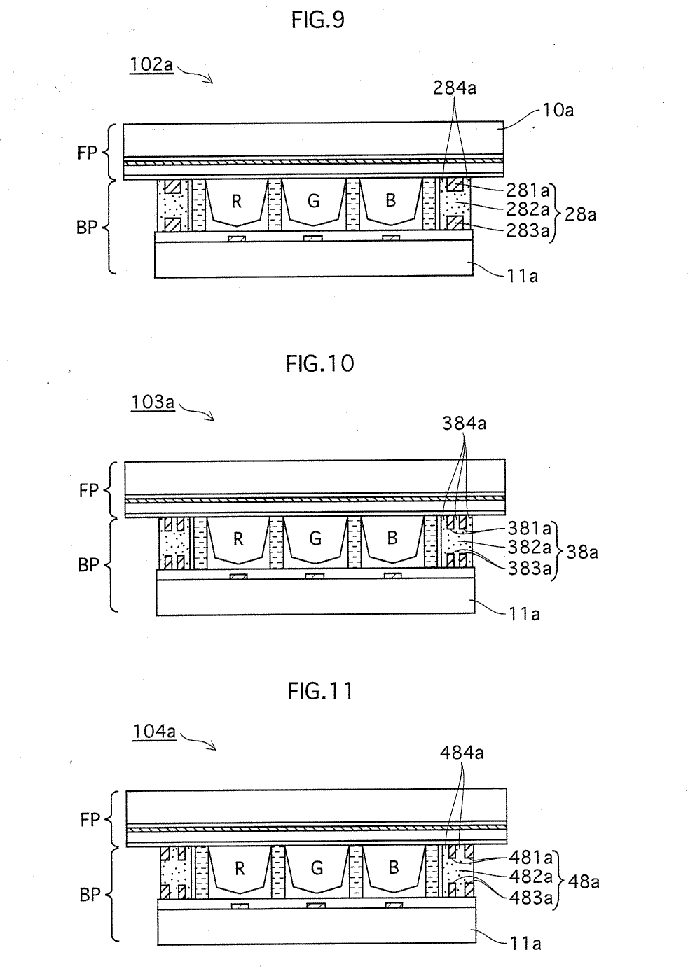

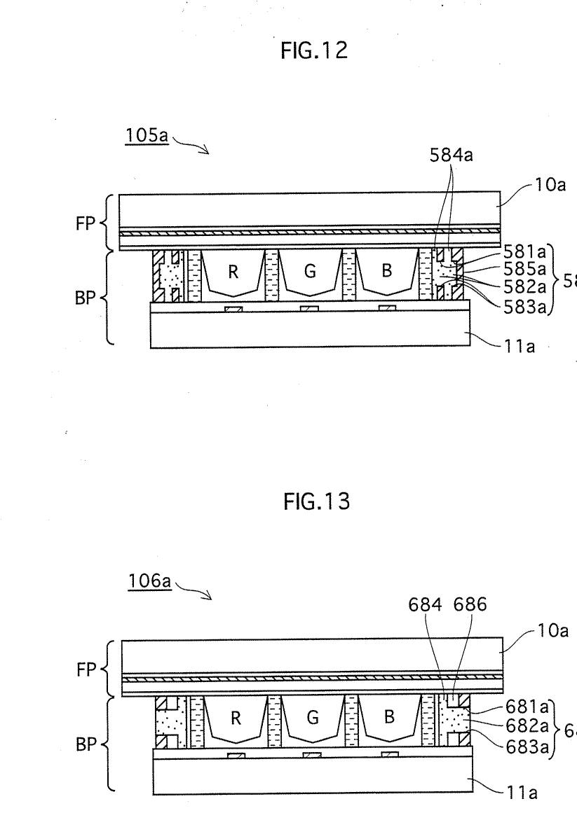

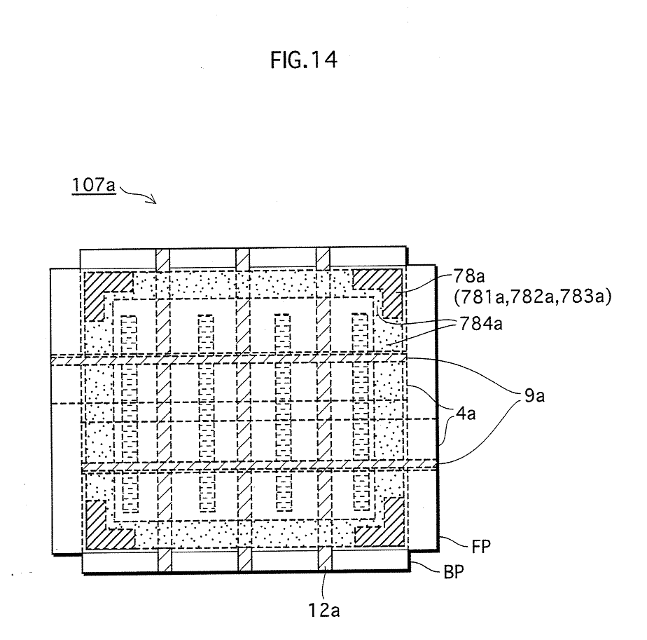

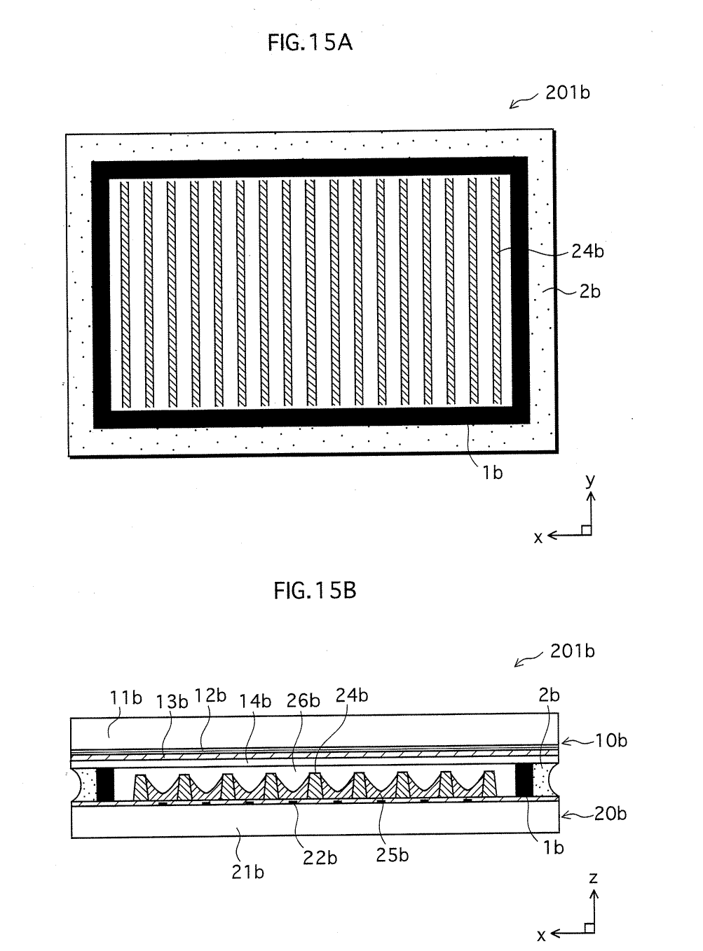

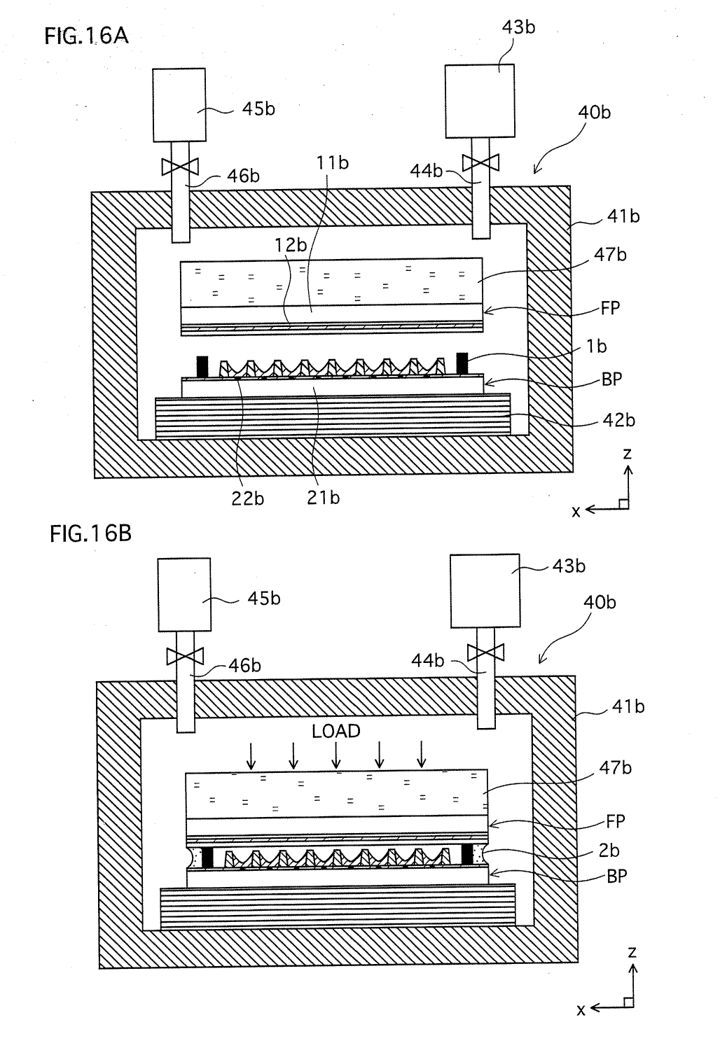

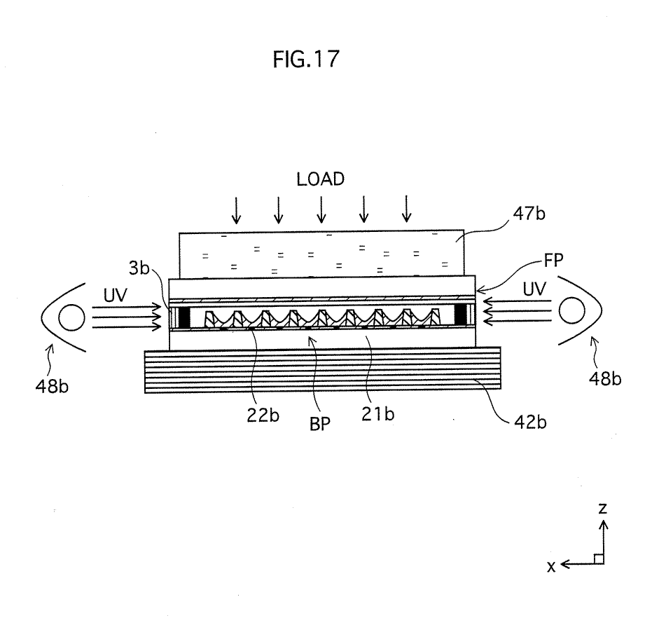

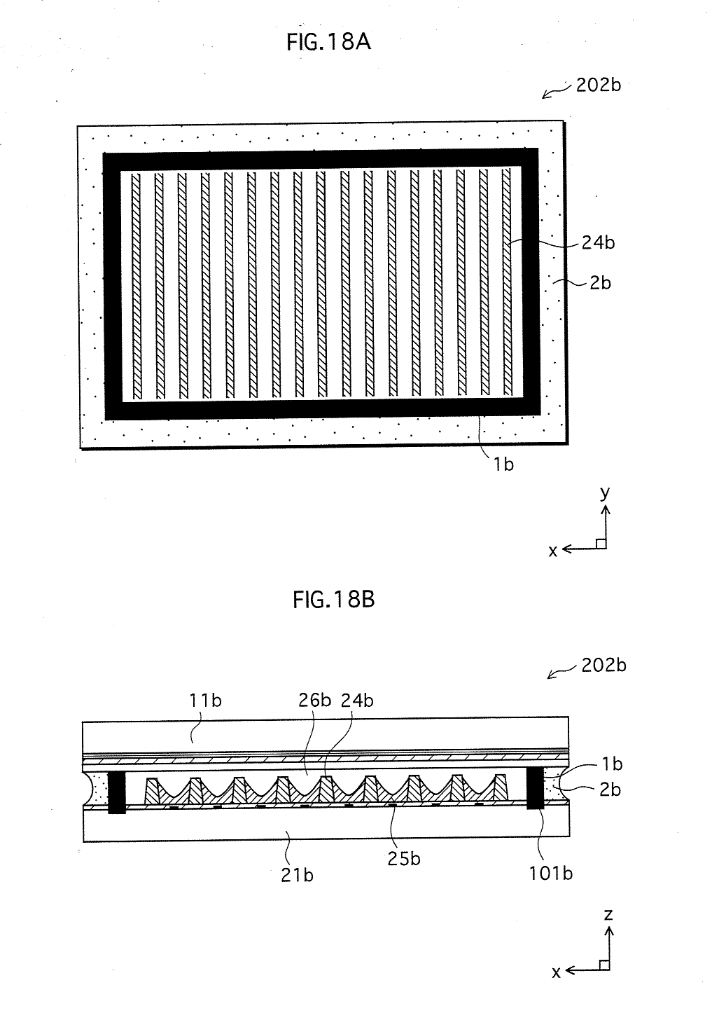

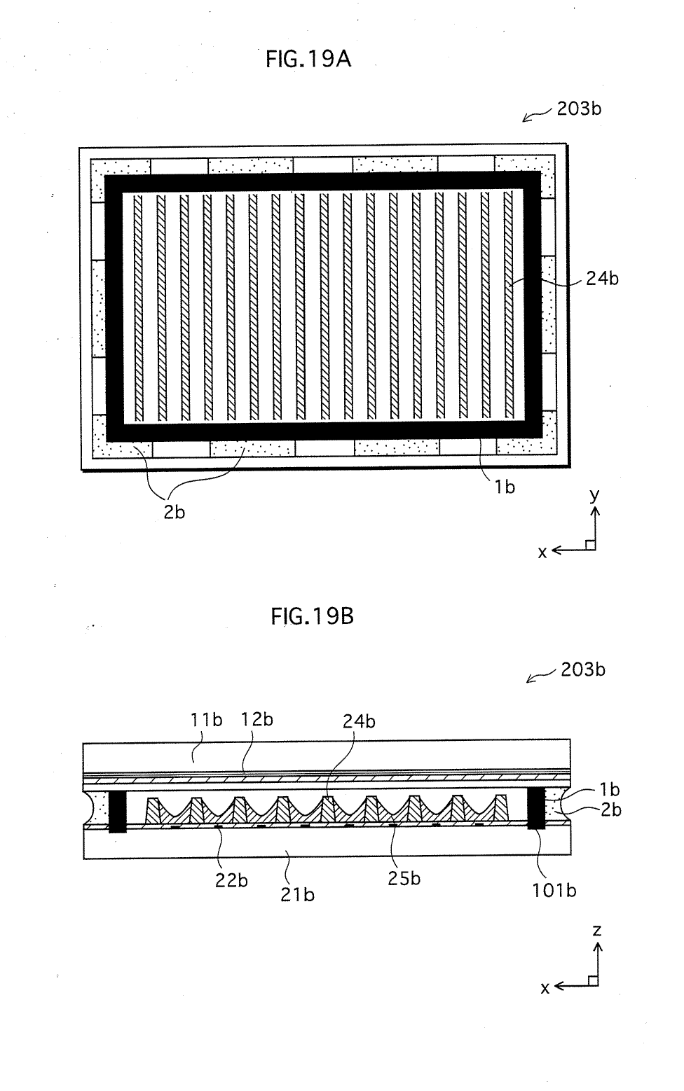

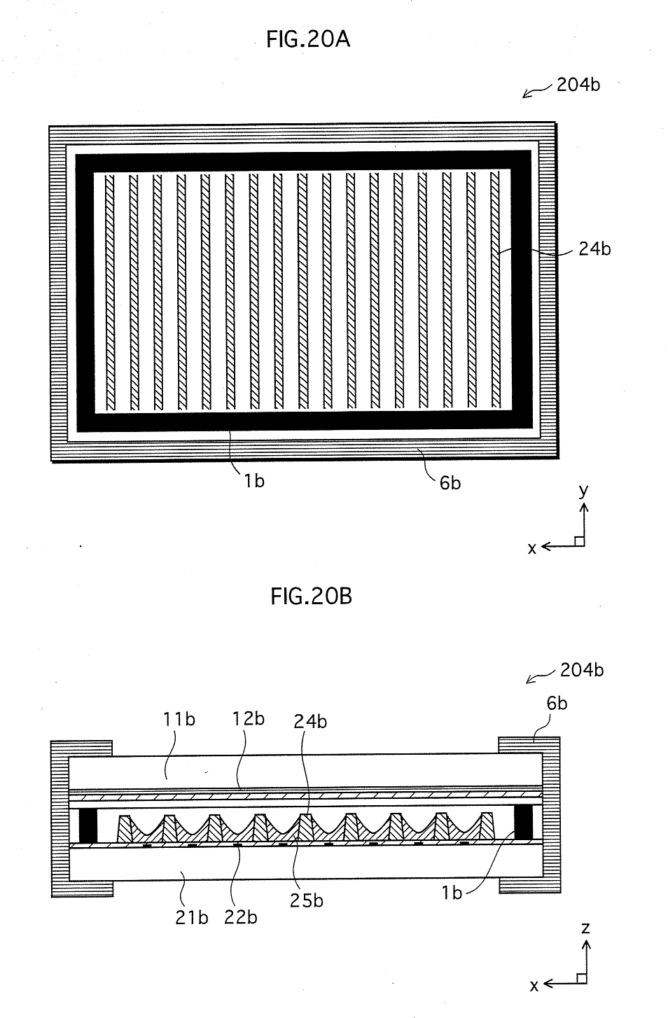

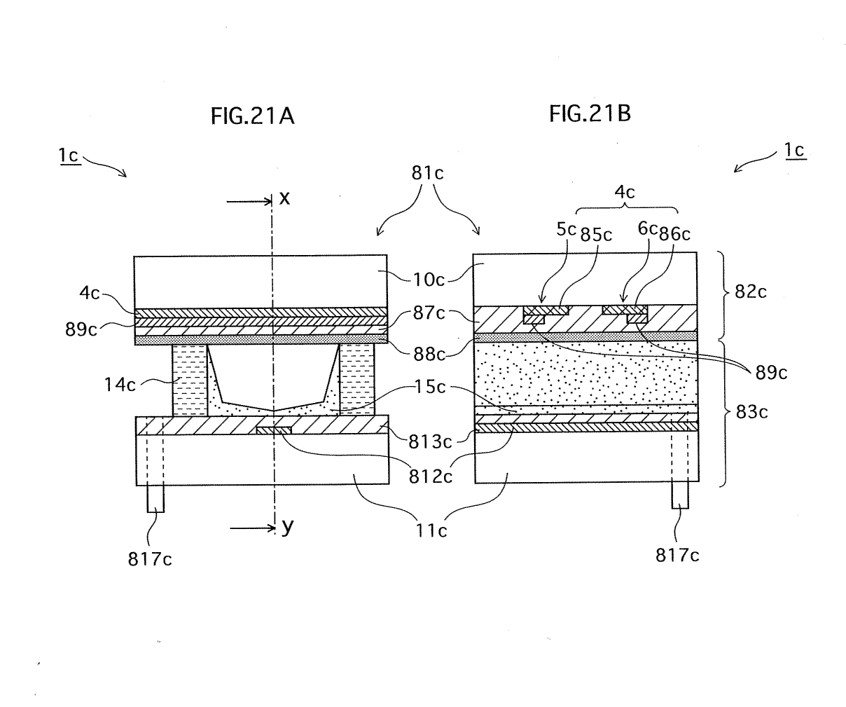

1. A plasma display panel including a front panel and a back panel arranged in opposing to each other at a certain gap, the front panel and the back panel being sealed by a sealing layer that is provided on entire peripheral portions of main surfaces of the front panel and the back panel, characterized in that:
the sealing layer is composed of at least one material selected from the group consisting of an organic resin material, an inorganic material, and a metal material.

2. The plasma display panel of claim 1, wherein
the sealing layer is formed under a reduced-pressure atmosphere in a discharge gas.

3. The plasma display panel of claim 1, wherein
a discharge gas is enclosed in an internal space between the front panel and the back panel through a flow passage.

4. The plasma display panel of claim 1, wherein
the sealing layer is a double enclosing layer composed of an inner layer and an outer layer on the main surfaces of the front panel and the back panel, and the outer layer is provided so as to surround the inner layer.

5. The plasma display panel of claim 4, wherein
one of the inner layer and the outer layer is a high-airtight enclosing layer, and the other is a high-strength enclosing layer.

6. The plasma display panel of claim 5, wherein
the inner layer is the high-strength enclosing layer, and the outer layer is the high-airtight enclosing layer.

7. The plasma display panel of claim 4, wherein
a width of each of the inner layer and the outer layer is different from each other along the main surfaces of the front panel and the back panel.

8. The plasma display panel of claim 7, wherein
when the double enclosing layer is composed of a high-strength enclosing layer and a high-airtight enclosing layer that is surrounded by the high-strength enclosing layer, the high-strength enclosing layer is wider than the high-airtight enclosing layer.

9. The plasma display panel of claim 1, wherein
a dielectric layer and a protective layer are formed in sequence on the main surface of at least one of the front panel and the back panel under a reduced-pressure atmosphere.

10. A manufacturing method of a plasma display panel having a sealing process of arranging a front panel and a back panel in opposing to each other at a certain gap, and sealing the front panel and the back panel by a sealing layer that is provided on entire peripheral portions of main surfaces of the front panel and the back panel, characterized in that:
in the sealing process, the front panel and the back panel are sealed by at least one material selected from the group consisting of an organic resin material, an inorganic material, and a metal material.

11. The manufacturing method of claim 10, wherein
in the sealing process, the front panel and the back panel are sealed in a discharge gas.

12. The manufacturing method of claim 10, wherein
the material of the sealing layer contains a silica material as a main component and an epoxy resin material.

13. The manufacturing method of claim 10, wherein
in the sealing process, the sealing layer is formed using at least one method out of a heating adhesion method, an ultraviolet cure method, a laser ablation method, and an ultrasonic welding method.

14. The manufacturing method of claim 13, wherein
when the heating adhesion method is used in the sealing process, an aging process is performed after the sealing process, and
in the aging process, the heating adhesion method is continuously performed supplementary.

15. The manufacturing method of claim 10, wherein
before the sealing process, a panel forming process is performed to compose at least one of the front panel and the back panel using a forming method in which a plurality of electrodes and a dielectric layer are formed on a main surface of a panel substrate in sequence, and
the panel forming process and the sealing process are continuously performed under a reduced-pressure atmosphere.

16. The manufacturing method of claim 10, wherein
before the sealing process, a panel forming process is performed to compose at least one of the front panel and the back panel using a forming method in which a plurality of electrodes and a dielectric layer are formed on a main surface of a panel substrate in sequence, and
in the panel forming process, the dielectric layer is formed using a CVD method.

17. The manufacturing method of claim 16, wherein
the CVD method is a plasma CVD method.

18. The manufacturing method of claim 10, wherein
before the sealing process, a panel forming process is performed to compose the front panel using a forming method in which a plurality of electrodes and a dielectric layer are formed on a main surface of a panel substrate in sequence and a protective layer is formed on the dielectric layer, and
in the panel forming process, the protective layer is formed using a vacuum process method.

19. The manufacturing method of claim 10, wherein
before the sealing process, an electrode forming process is performed to form a plurality of electrodes on at least one of main surfaces of panel substrates of the front panel and the back panel, and
in the electrode forming process, the plurality of electrodes are formed by an Al—Nd material using a vacuum process method.

20. The manufacturing method of claim 10, wherein
before the sealing process, a panel forming process is performed to compose the front panel using a forming method in which a plurality of electrodes, a dielectric layer, and a protective layer are formed on a main surface of a panel substrate in sequence, and
the panel forming process is performed at a low temperature in a range of an ambient temperature to 300° C. inclusive.

21. A plasma display panel including a front panel and a back panel arranged in opposing to each other with a discharge space in between, the front panel and the back panel being sealed by a sealing layer that is provided on entire peripheral portions of main surfaces of the front panel and the back panel, characterized in that:
at least in one part of the sealing layer, a laminated area including adhesion layers and a seal layer in between is formed along thickness directions of the front panel and the back panel.

22. The plasma display panel of claim 21, wherein
the sealing layer is formed under a reduced-pressure atmosphere in a discharge gas.

23. The plasma display panel of claim 21, wherein
each of the adhesion layers has a higher adhesive strength characteristic than that of the seal layer, and
the seal layer has a higher airtight characteristic than that of each of the adhesion layers.

24. The plasma display panel of claim 21, wherein
the seal layer is formed at least in an area exposed to the discharge space.

25. The plasma display panel of claim 21, wherein
a high-airtight enclosing layer is formed at least in a most external circumferential portion of the sealing layer.

26. The plasma display panel of claim 21, wherein
in the sealing layer, the laminated area is arranged in a plurality of portions on the main surfaces of the front panel and the back panel.

27. The plasma display panel of claim 21, wherein
in the sealing layer, the laminated area is arranged in different portions in width directions along the main surfaces of the front panel and the back panel.

28. The plasma display panel of claim 21, wherein
a most external circumferential portion of the sealing layer is composed of another adhesion layer, and
the adhesion layer is arranged on the entire peripheral portions of the main surfaces of the front panel and the back panel.

29. The plasma display panel of claim 21, wherein
a void portion exists in the sealing layer along the main surfaces of the front panel and the back panel, and the void portion is contactless with any of an outside and the discharge space.

30. The plasma display panel of claim 21, wherein
a material of the seal layer contains a silica material as a main component and an organic resin material.

31. The plasma display panel of claim 21, wherein
a material of the seal layer contains a vacuum packing material.

32. The plasma display panel of claim 21, wherein
the adhesion layer is composed of at least one material selected from the group consisting of an organic sealing layer material and a composite sealing layer material.

33. A manufacturing method of a plasma display panel having a sealing process of providing a sealing layer material on an entire peripheral portion of a main surface of at least one of a front panel and a back panel, and arranging the front panel and the back panel in opposing to each other to be sealed, characterized in that:
in the sealing process, the sealing layer material is applied and cured to form the sealing layer including a laminated structure composed of adhesion layers and a seal layer in between.

34. The manufacturing method of claim 33, wherein
the sealing process is performed in a chamber in which a predetermined discharge gas is filled, and the discharge gas is enclosed in an internal space between the front panel and the back panel.

35. The manufacturing method of claim 33, wherein
the sealing process is performed using at least one method out of a heating adhesion method, an ultraviolet cure method, a laser ablation method, and an ultrasonic welding method.

36. A plasma display panel including a front panel and a back panel arranged in opposing to each other at a certain gap, the front panel and the back panel being sealed by a sealing layer that is provided on peripheral portions of main surfaces of the front panel and the back panel, characterized in that:
a gasket layer is more internally arranged than the sealing layer along the main surfaces of the front panel and the back panel.

37. The plasma display panel of claim 36, wherein
a material of the gasket layer contains a metal material.

38. The plasma display panel of claim 37, wherein
the metal material is composed of at least one material selected from the group consisting of Cu, Al, Zn, Ag, and In.

39. The plasma display panel of claim 36, wherein
the sealing layer is composed of at least one material selected from the group consisting of a thermoset material, an ultraviolet cure material, and a glass material.

40. The plasma display panel of claim 36, wherein
a thickness of each of the sealing layer and the gasket layer is different from each other along the main surfaces of the front panel and the back panel.

41. The plasma display panel of claim 40, wherein
the sealing layer is thicker than the gasket layer.

42. The plasma display panel of claim 36, wherein
in the main surface of at least one of the front panel and the back panel, a groove-like depression is formed in one or more portions to fit the sealing layer.

43. The plasma display panel of claim 36, wherein
the sealing layer is provided intermittently along the main surfaces of the front panel and the back panel.

44. A manufacturing method of a plasma display panel having a sealing process of arranging a front panel and a back panel in opposing to each other at a certain gap, and sealing the front panel and the back panel by a sealing layer that is provided on peripheral portions of main surfaces of the front panel and the back panel, characterized in that:
in the sealing process, a gasket layer is more internally arranged than the sealing layer along the main surfaces of the front panel and the back panel while the sealing layer is arranged.

45. A manufacturing method of a plasma display panel having a sealing process of arranging a front panel and a back panel in opposing to each other, and providing materials of a gasket layer and a sealing layer on peripheral portions of main surfaces of the front panel and the back panel, characterized in that:
in the sealing process, a discharge gas is enclosed in an internal space between the front panel and the back panel, and the front panel and the back panel are sealed by the sealing layer under a reduced-pressure atmosphere in the discharge gas.
